(19) United States
(12) Patent Application Publication
(10) Pub. No.: US 2019/0102038 A1
(43) Pub. Date: Apr. 4, 2019

(54) DETECTION APPARATUS AND DISPLAY APPARATUS

(71) Applicant: Japan Display Inc., Tokyo (JP)

(72) Inventors: Toshinori UEHARA, Tokyo (JP); Hayato KURASAWA, Tokyo (JP); Takanori TSUNASHIMA, Tokyo (JP); Kenshi TADA, Tokyo (JP)

(21) Appl. No.: 16/137,174

(22) Filed: Sep. 20, 2018

(30) Foreign Application Priority Data
Sep. 29, 2017 (JP) 2017-192176

(51) Int. Cl. G06F 3/041; G06K 9/00; G06F 3/044

(52) U.S. Cl. CPC G06F 3/0416; G06F 3/044; G06K 9/0002

(57) ABSTRACT

A detection apparatus includes a substrate, a plurality of first electrodes provided on the substrate, and a first electrode selection circuit provided on the substrate and including a first selection circuit configured to provide a first selection signal having a phase determined for each of the plurality of first electrodes and a second selection circuit configured to provide a second selection signal having a phase determined for each of first electrode blocks including the plurality of first electrodes.

### CROSS-REFERENCE TO RELATED APPLICATIONS

This application claims priority from Japanese Application No. 2017-192176, filed on Sep. 29, 2017, the contents of which are incorporated by reference herein in its entirety.

### BACKGROUND

### 1. Technical Field

The present disclosure relates to a detection apparatus and a display apparatus.

### 2. Description of the Related Art

There have recently been demands for performing fingerprint detection for personal identification by a capacitance method, for example. To perform fingerprint detection, electrodes having a smaller area are used than those used to detect contact of hands and fingers. Even if signals are obtained from such smaller electrodes, satisfactory detection sensitivity can be provided by code division multiplexing drive. Code division multiplexing drive is a driving method of selecting a plurality of drive electrodes simultaneously and supplying drive signals having the phases determined based on a predetermined code to the respective selected drive electrodes (refer to Japanese Patent Application Laid-open Publication No. 2014-199605 (JP-A-2014-199605).

In the display apparatus with a touch detection function described in JP-A-2014-199605, shift registers are provided for respective drive electrode blocks. The shift registers operate to sequentially supply selection signals to the respective drive electrode blocks. As a result, the drive electrode blocks are selected one by one. With this configuration, however, an increase in the number of electrodes may possibly increase the circuit size of the shift registers and the other components. The size and the required resolution for an object to be detected differ between touch detection and fingerprint detection. Consequently, drive circuits used for touch detection may possibly fail to perform fingerprint detection satisfactorily.

### SUMMARY

A detection apparatus according to one embodiment of the present disclosure includes a substrate, a plurality of first electrodes provided on the substrate, and a first electrode selection circuit provided on the substrate and including a first selection circuit configured to provide a first selection signal having a phase determined for each of the plurality of first electrodes and a second selection circuit configured to provide a second selection signal having a phase determined for each of first electrode blocks including the plurality of first electrodes. The first electrode selection circuit has a first detection mode of supplying same signal of the first drive signal to each of the first electrode blocks in a time-division manner based on the first selection signal and the second selection signal, and the first electrode selection circuit has a second detection mode of supplying, to the plurality of first electrodes, a second drive signal having a phase determined for each of the plurality of first electrodes based on the first selection signal and the second selection signal.

A detection apparatus according to one embodiment of the present disclosure includes a substrate, a plurality of first electrode blocks provided on the substrate, each of the first electrode blocks including a plurality of first electrodes, and a first electrode selection circuit provided on the substrate and including a first selection circuit configured to provide a first selection signal having a phase determined for each of the plurality of first electrodes included in one first electrode block and a second selection circuit configured to provide a second selection signal for each of the first electrode blocks including the plurality of first electrodes. The first selection circuit supplies, in at least the first electrode blocks disposed side by side, same signal of the first selection signal to electrodes provided respectively at the same position in the direction in which the first electrode blocks are disposed side by side, the second selection circuit supplies same signal of the second drive signal to first electrodes included in at least one first electrode block, the first electrode selection circuit has a first detection mode of supplying same signal of the first drive signal to each of the first electrode blocks in a time-division manner based on the first selection signal and the second selection signal, and the first electrode selection circuit has a second detection mode of supplying, to the plurality of first electrodes, a second drive signal having a phase determined for each of the plurality of first electrodes based on the first selection signal and the second selection signal.

A display apparatus according to one embodiment of the present disclosure includes the detection apparatus described above, and a display panel configured to display an image. The detection apparatus is provided on the display panel.

A display apparatus according to one embodiment of the present disclosure includes the detection apparatus described above, and a display panel configured to display an image. The plurality of first electrodes are common electrodes configured to supply a common potential to a plurality of pixels in the display panel.

### BRIEF DESCRIPTION OF THE DRAWINGS

FIG. 1 is a plan view of a display apparatus including a detection apparatus according to a first embodiment of the present disclosure;

FIG. 2 is a sectional view along line II-II′ in FIG. 1;

FIG. 3 is a block diagram of an exemplary configuration of the detection apparatus according to the first embodiment;

FIG. 4 is a diagram for explaining mutual capacitance touch detection;

FIG. 5 is a plan view of the detection apparatus according to the first embodiment;

FIG. 6 is an enlarged plan view of part of first electrodes and second electrodes;

FIG. 7 is a sectional view along line VII-VII′ in FIG. 6;

FIG. 8 is a view for explaining a first detection mode of the detection apparatus according to the first embodiment;

FIG. 9 is a view for explaining a second detection mode of the detection apparatus according to the first embodiment;

FIG. 10 is a view for explaining a third detection mode of the detection apparatus according to the first embodiment;

FIG. 11 is a view for explaining a fourth detection mode of the detection apparatus according to the first embodiment;

FIG. 12 is a diagram for explaining an exemplary operation in code division multiplexing drive;

FIG. 13 is a diagram for explaining another exemplary operation in code division multiplexing drive;

FIG. 14 is a block diagram of a first electrode selection circuit according to the first embodiment;

FIG. 15 is a block diagram of a first selection circuit of the first electrode selection circuit;

FIG. 16 is a timing waveform chart of an exemplary operation performed by a counter circuit;

FIG. 17 is a circuit diagram of an example of a first code generation circuit;

FIG. 18 is a table indicating the relation between first control signals and first partial selection signals;

FIG. 19 is a circuit diagram of an example of a second code generation circuit;

FIG. 20 is a table indicating the relation between second control signals and an inversion control signal, and second partial selection signals;

FIG. 21 is a circuit diagram of an example of a third code generation circuit;

FIG. 22 illustrates an example of a pattern code generated by the third code generation circuit if the inversion control signal is at a high-level voltage;

FIG. 23 illustrates an example of a pattern code generated by the third code generation circuit if the inversion control signal is at a low-level voltage;

FIG. 24 is a table indicating the relation between the first control signals, the second control signals and the inversion control signal, and detection signals;

FIG. 25 is a block diagram of a second selection circuit of the first electrode selection circuit;

FIG. 26 is a table indicating the relation between a first selection signal, a second selection signal, a first electrode block selection signal, and a drive signal;

FIG. 27 is a table indicating the relation between first electrode blocks and the selection signals in the second detection mode;

FIG. 28 is a timing waveform chart of the first electrode selection circuit in the second detection mode;

FIG. 29 is a table indicating the second selection signals for the respective first electrode blocks in each holding period;

FIG. 30 is a table indicating another example of the second selection signals for the respective first electrode blocks in each holding period;

FIG. 31 is a table indicating the relation between the first electrode blocks and the selection signals in the third detection mode;

FIG. 32 is a timing waveform chart of the first electrode selection circuit in the third detection mode;

FIG. 33 is a table indicating the relation between the first electrode blocks and the selection signals in TDM drive in the first detection mode;

FIG. 34 is a timing waveform chart of the first electrode selection circuit in TDM drive in the first detection mode;

FIG. 35 is a table indicating the relation between the first electrode blocks and the selection signals in CDM drive in the first detection mode;

FIG. 36 is a timing waveform chart of the first electrode selection circuit in CDM drive in the first detection mode;

FIG. 37 is a circuit diagram of a detection electrode selection circuit according to the first embodiment;

FIG. 38 is a circuit diagram of another example of the detection electrode selection circuit according to the first embodiment;

FIG. 39 is a block diagram of the first electrode selection circuit according to a second embodiment of the present disclosure;

FIG. 40 is a block diagram of the first selection circuit of the first electrode selection circuit according to the second embodiment;

FIG. 41 is a table indicating the relation between the first electrode blocks and the selection signals if the inversion control signal is turned off in the second detection mode;

FIG. 42 is a table indicating the relation between the first electrode blocks and the selection signals if the inversion control signal is turned on in the second detection mode;

FIG. 43 is a table indicating the relation between the first electrode blocks and the selection signals if the inversion control signal is turned off in the third detection mode;

FIG. 44 is a table indicating the relation between the first electrode blocks and the selection signals if the inversion control signal is turned on in the third detection mode;

FIG. 45 is a table indicating the relation between the first electrode blocks and the selection signals if the inversion control signal is turned off in TDM drive in the first detection mode;

FIG. 46 is a table indicating the relation between the first electrode blocks and the selection signals if the inversion control signal is turned on in TDM drive in the first detection mode;

FIG. 47 is a table indicating the relation between the first electrode blocks and the selection signals if the inversion control signal is turned off in CDM drive in the first detection mode;

FIG. 48 is a table indicating the relation between the first electrode blocks and the selection signals if the inversion control signal is turned on in CDM drive in the first detection mode;

FIG. 49 is a block diagram of the first electrode selection circuit according to a third embodiment of the present disclosure;

FIG. 50 is a sectional view of a schematic sectional structure of the display apparatus including the detection apparatus according to a fourth embodiment of the present disclosure; and

FIG. 51 is a plan view of the detection apparatus according to the fourth embodiment.

### DETAILED DESCRIPTION

Exemplary aspects (embodiments) to embody the present disclosure are described below in greater detail with reference to the accompanying drawings. The contents described in the embodiments are not intended to limit the present disclosure. Components described below include components easily conceivable by those skilled in the art and components substantially identical therewith. Furthermore, the components described below may be appropriately combined. What is disclosed herein is given by way of example only, and appropriate modifications made without departing from the spirit of the present disclosure and easily conceivable by those skilled in the art naturally fall within the scope of the disclosure. To simplify the explanation, the drawings may possibly illustrate the width, the thickness, the shape, and other elements of each component more schematically than the actual aspect. These elements, however, are given by way of example only and are not intended to limit interpretation of the present disclosure. In the present specification and the figures, components similar to those previously described with reference to previous figures are denoted by like reference numerals, and detailed explanation thereof may be appropriately omitted.

### First embodiment

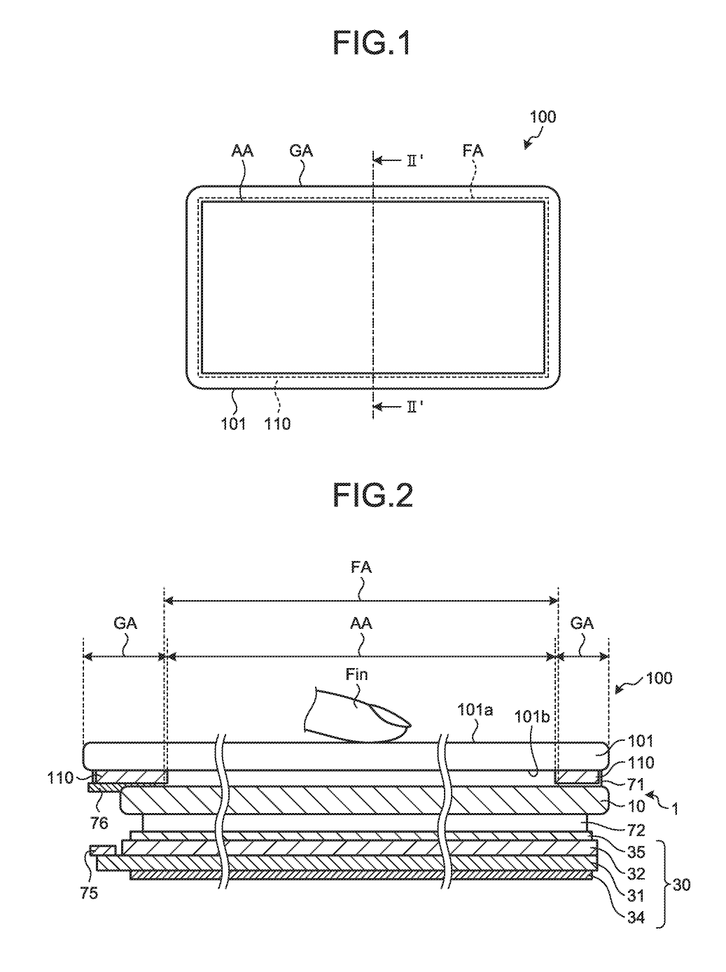

FIG. 1 is a plan view of a display apparatus including a detection apparatus according to a first embodiment of the present disclosure. FIG. 2 is a sectional view along line II-II′ in FIG. 1. As illustrated in FIGS. 1 and 2, a display apparatus 100 according to the present embodiment has a display region AA, a frame region GA, and a detection region FA. The display region AA is a region for displaying an image on a display panel 30. The frame region GA is a region positioned outside the display region AA. The detection region FA is a region for detecting unevenness on the surface of a finger or the like in contact with or in proximity to the display apparatus 100. The detection region FA overlaps the whole surface of the display region AA.

As illustrated in FIG. 2, the display apparatus 100 according to the present embodiment includes a cover member 101, a detection apparatus 1, and the display panel 30. The cover member 101 is a plate-like member having a first surface 101a and a second surface 101b opposite to the first surface 101a. The first surface 101a of the cover member 101 serves as a detection surface that detects unevenness on the surface of a finger Fin or the like in contact with or in proximity to the display apparatus 100 and as a display surface that displays an image on the display panel 30. The display panel 30 and a sensor 10 of the detection apparatus 1 are provided on the second surface 101b side of the cover member 101. The cover member 101 protects the sensor 10 and the display panel 30 and is provided to cover them. The cover member 101 is a glass substrate or a resin substrate, for example.

The cover member 101, the sensor 10, and the display panel 30 do not necessarily have a rectangular shape in planar view. The cover member 101, the sensor 10, and the display panel 30 may have a circular shape, an elliptical shape, or a deformed shape obtained by removing part of the outer shapes described above. The cover member 101, the sensor 10, and the display panel 30 may have different outer shapes. For example, the cover member 101 may have a circular shape, and the sensor 10 and the display panel 30 may have a regular polygonal shape. The cover member 101 does not necessarily have a flat plate shape. The display apparatus 100 may be a curved surface display having a curved surface in which the display region AA has a curved surface or in which the frame region GA is bent toward the display panel 30, for example.

As illustrated in FIGS. 1 and 2, a decorative layer 110 is provided in the frame region GA on the second surface 101b of the cover member 101. The decorative layer 110 is a colored layer having light transmittance lower than that of the cover member 101. The decorative layer 110 can prevent wiring, circuits, and other components provided overlapping the frame region GA from being visually recognized by an observer. While the decorative layer 110 is provided on the second surface 101b in the example illustrated in FIG. 2, it may be provided on the first surface 101a. The decorative layer 110 is not limited to a single layer and may have a multilayered structure including a plurality of layers.

The detection apparatus 1 includes the sensor 10 that detects unevenness on the surface of the finger Fin or the like in contact with or in proximity to the first surface 101a of the cover member 101. As illustrated in FIG. 2, the sensor 10 of the detection apparatus 1 is provided on the display panel 30. In other words, the sensor 10 is provided between the cover member 101 and the display panel 30 and overlaps the display panel 30 when viewed in a direction perpendicular to the first surface 101a. The sensor 10 is coupled to a flexible printed circuit board 76. The flexible printed circuit board 76 can output detection signals received from the sensor 10 to the outside.

One surface of the sensor 10 is bonded to the cover member 101 with an adhesive layer 71 interposed therebetween. The other surface of the sensor 10 is bonded to a polarizing plate 35 of the display panel 30 with an adhesive layer 72 interposed therebetween. The adhesive layer 71 is an optical clear resin (OCR) or a liquid optically clear adhesive (LOCA) serving as a liquid UV-curable resin, for example. The adhesive layer 72 is an optical clear adhesive (OCA), for example.

The display panel 30 includes a first substrate 31, a second substrate 32, a polarizing plate 34, and the polarizing plate 35. The polarizing plate 34 is provided under the first substrate 31. The polarizing plate 35 is provided on the second substrate 32. The first substrate 31 is coupled to a flexible printed circuit board 75. Liquid crystal display elements are provided between the first substrate 31 and the second substrate 32 to serve as a display layer. In other words, the display panel 30 is a liquid crystal panel. The display panel 30 is not limited thereto and may be an organic light-emitting diode (OLED), for example.

As illustrated in FIG. 2, the sensor 10 is disposed closer to the cover member 101 than the display panel 30 in a direction perpendicular to the second surface 101b of the cover member 101. This configuration can reduce the distance between detection electrodes for fingerprint detection and the first surface 101a serving as a detection surface compared with a case where the detection electrodes are integrated with the display panel 30, for example. Consequently, the display apparatus 100 including the detection apparatus 1 according to the present embodiment can improve the detection performance.

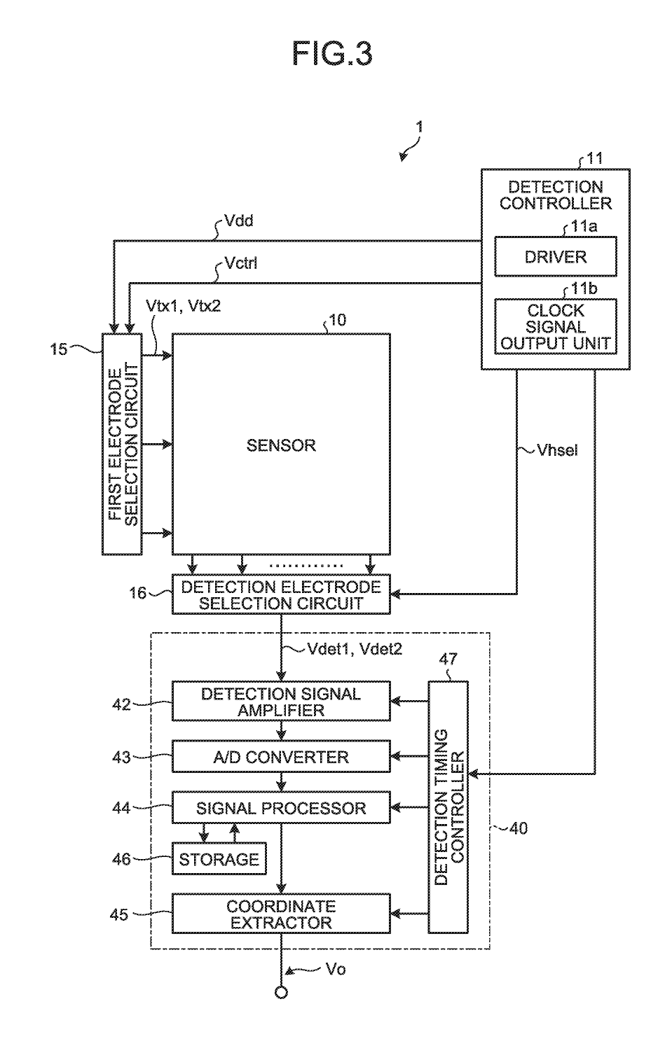

The following describes the configuration of the detection apparatus 1 in greater detail. FIG. 3 is a block diagram of an exemplary configuration of the detection apparatus according to the first embodiment. As illustrated in FIG. 3, the detection apparatus 1 includes the sensor 10, a detection controller 11, a first electrode selection circuit 15, a detection electrode selection circuit 16, and a detector 40.

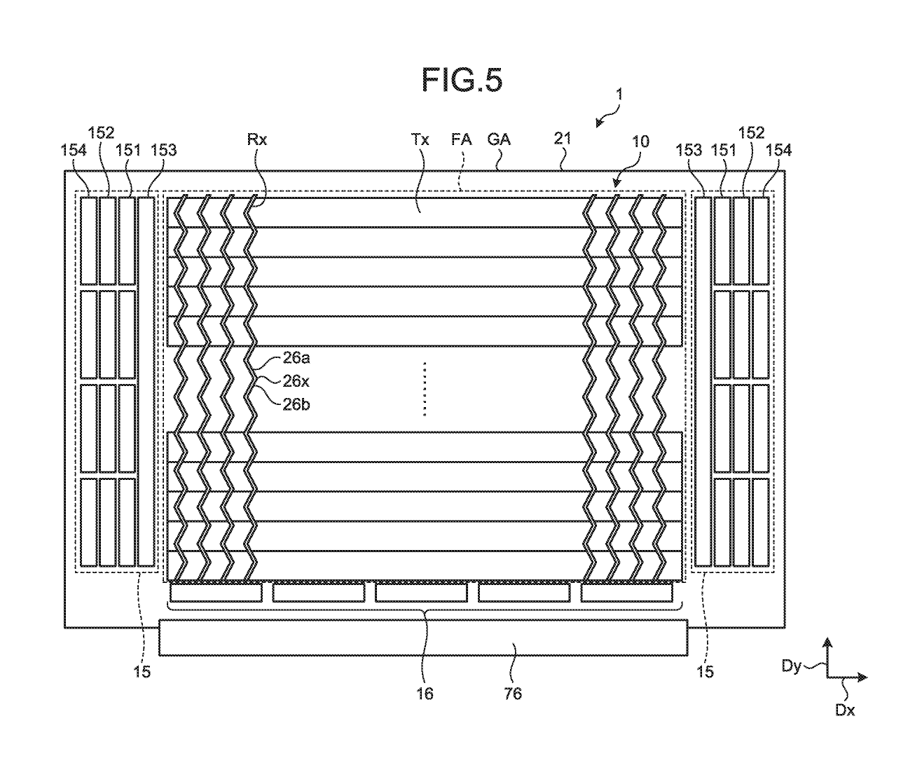

The sensor 10 performs detection based on second drive signals Vtx2 supplied from the first electrode selection circuit 15 by code division multiplexing drive (hereinafter, referred to as CDM drive). In other words, the sensor 10 selects a plurality of first electrodes Tx (refer to FIG. 5) simultaneously by operations of the first electrode selection circuit 15. The first electrode selection circuit 15 supplies the second drive signals Vtx2 having the phases determined based on a predetermined code to the respective selected first electrodes Tx. The sensor 10 detects unevenness on the surface of the finger Fin or a hand in contact with or in proximity to the detection apparatus 1 based on a mutual capacitance method, thereby detecting the shape of a fingerprint or a palm print.

The sensor 10 can also detect the position of the finger Fin or the like in contact with or in proximity to the detection apparatus 1 based on first drive signals Vtx1 supplied from the first electrode selection circuit 15 by time division multiplexing drive (hereinafter, referred to as TDM drive). In TDM drive, the sensor 10 scans first electrode blocks BK each including a plurality of first electrodes Tx one by one, thereby performing detection on the whole detection region FA.

The detection controller 11 is a circuit that supplies control signals to the first electrode selection circuit 15, the detection electrode selection circuit 16, and the detector 40 to control their operations. The detection controller 11 includes a driver 11a and a clock signal output unit 11b. The driver 11a supplies a power source voltage Vdd to the first electrode selection circuit 15. The detection controller 11 supplies various control signals Vctr1 to the first electrode selection circuit 15 based on clock signals supplied from the clock signal output unit 11b.

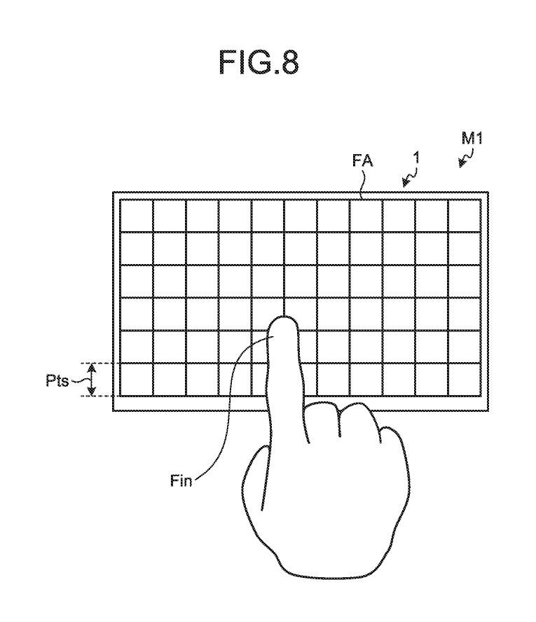

The first electrode selection circuit 15 selects a plurality of first electrodes Tx simultaneously based on the various control signals Vctr1. The first electrode selection circuit 15 supplies the first drive signals Vtx1 or the second drive signals Vtx2 to the selected first electrodes Tx. The first electrode selection circuit 15 changes the state of selecting the first electrodes Tx, whereby the sensor 10 can perform a plurality of detection modes, that is, a first detection mode M1, a second detection mode M2, a third detection mode M3, and a fourth detection mode M4 (refer to FIGS. 8 to 11).

The detection electrode selection circuit 16 is a switch circuit that selects a plurality of second electrodes Rx (refer to FIG. 5) simultaneously. The detection electrode selection circuit 16 performs CDM drive based on second electrode selection signals Vhsel supplied from the detection controller 11. As a result, the detection electrode selection circuit 16 selects a plurality of second electrodes Rx.

The detector 40 is a circuit that determines whether a touch is made at a fine pitch based on the control signals supplied from the detection controller 11 and on first detection signals Vdet1 and second detection signals Vdet2 supplied from the sensor 10 in CDM drive. The detector 40 includes a detection signal amplifier 42, an analog/digital (A/D) converter 43, a signal processor 44, a coordinate extractor 45, a storage 46, and a detection timing controller 47. The detection timing controller 47 controls the detection signal amplifier 42, the A/D converter 43, the signal processor 44, and the coordinate extractor 45 such that they operate synchronously with one another based on the control signals supplied from the detection controller 11. In the following description, the first detection signals Vdet1 and the second detection signals Vdet2 are simply referred to as detection signals Vdet when they need not be distinguished from each other.

The sensor 10 supplies the first detection signals Vdet1 and the second detection signals Vdet2 to the detection signal amplifier 42. The detection signal amplifier 42 amplifies the first detection signals Vdet1 and the second detection signals Vdet2. The A/D converter 43 converts analog signals output from the detection signal amplifier 42 into digital signals.

The signal processor 44 is a logic circuit that determines whether a touch is made on the sensor 10 based on the output signals from the A/D converter 43. The signal processor 44 receives the first detection signals Vdet1 and the second detection signals Vdet2 from the first electrodes Tx via the detection electrode selection circuit 16 and calculates third detection signals Vdet3. The signal processor 44 receives the calculated third detection signals Vdet3 and performs decoding on them based on a predetermined code.

The detector 40 determines whether a touch is made based on the control signals supplied from the detection controller 11 and the detection signals Vdet supplied from the sensor 10 in TDM drive. In TDM drive, the signal processor 44 receives the detection signals Vdet from the first electrodes Tx via the detection electrode selection circuit 16. The signal processor 44 performs processing of extracting a signal (absolute value |ΔV|) of difference between the detection signals Vdet caused by a finger. The signal processor 44 compares the absolute value |ΔV| with a predetermined threshold voltage. If the absolute value |ΔV| is lower than the threshold voltage, the signal processor 44 determines that an external proximity object is in a non-contact state. By contrast, if the absolute value |ΔV| is equal to or higher than the threshold voltage, the signal processor 44 determines that an external proximity object is in a contact state.

The storage 46 temporarily stores therein the calculated third detection signals Vdet3. The storage 46 is a random access memory (RAM), a read only memory (ROM), or a register circuit, for example.

The coordinate extractor 45 calculates the touch panel coordinates based on the signal of difference between the detection signals and outputs the obtained touch panel coordinates as sensor output Vo. The coordinate extractor 45 may output the decoded signals as the sensor output Vo without calculating the touch panel coordinates.

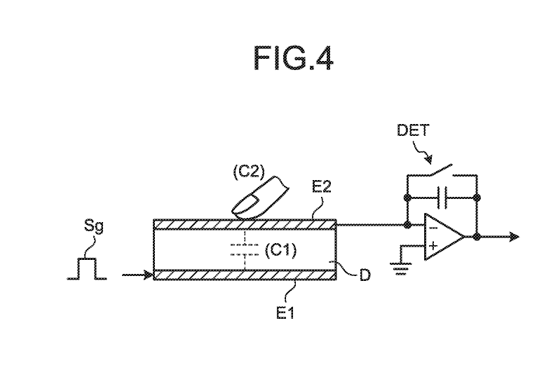

The detection apparatus 1 performs capacitance touch detection. The following describes mutual capacitance touch detection performed by the detection apparatus 1 according to the present embodiment with reference to FIG. 4. FIG. 4 is a diagram for explaining mutual capacitance touch detection. FIG. 4 also illustrates a detection circuit.

As illustrated in FIG. 4, a capacitance element C1 includes a pair of electrodes, that is, a drive electrode E1 and a detection electrode E2 facing each other with a dielectric D interposed therebetween. The capacitance element C1 generates fringe lines of electric force extending from ends of the drive electrode E1 to the upper surface of the detection electrode E2 besides lines of electric force (not illustrated) formed between the facing surfaces of the drive electrode E1 and the detection electrode E2. A first end of the capacitance element C1 is coupled to an alternating-current (AC) signal source (drive signal source), and a second end thereof is coupled to a voltage detector DET. The voltage detector DET is an integration circuit included in the detector 40 illustrated in FIG. 3, for example.

The AC signal source applies an AC rectangular wave Sg at a predetermined frequency (e.g., a frequency of the order of several kilohertz to several hundred kilohertz) to the drive electrode E1 (first end of the capacitance element C1). An electric current corresponding to the capacitance value of the capacitance element C1 flows through the voltage detector DET. The voltage detector DET converts fluctuations in the electric current depending on the AC rectangular wave Sg into fluctuations in the voltage.

When capacitance C2 formed by a finger is in contact with the detection electrode E2 or comes closer to the detection electrode E2 close enough to consider it in contact therewith, the fringe lines of electric force between the drive electrode E1 and the detection electrode E2 are blocked by the conductor (finger). As a result, the capacitance element C1 acts as a capacitance element having a capacitance value smaller than that in a non-contact state as the capacitance C2 comes closer to the detection electrodes E2.

The amplitude of the voltage signals output from the voltage detector DET becomes smaller as unevenness or the like on the finger Fin approaches the contact state compared with the non-contact state. The absolute value |ΔV| of the voltage difference varies depending on an effect of an object to be detected in contact with or in proximity to the detection electrode E2. The detector 40 determines unevenness or the like on the finger Fin based on the absolute value |ΔV|. The detector 40 compares the absolute value |ΔV| with the predetermined threshold voltage, thereby determining whether the object to be detected is in the non-contact state or in the contact state or a proximity state. The detector 40 thus can perform mutual capacitance touch detection. The “contact state” includes a state where a finger is in contact with the detection surface or in proximity to the detection surface close enough to consider it in contact therewith. The “non-contact state” includes a state where a finger is neither in contact with the detection surface nor in proximity to the detection surface close enough to consider it in contact therewith.

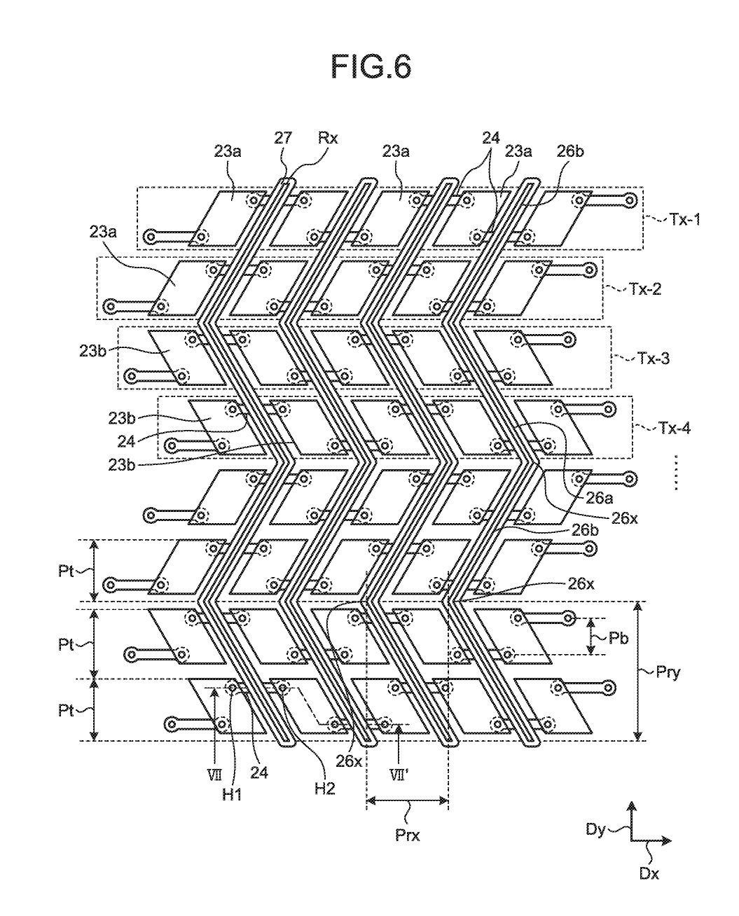

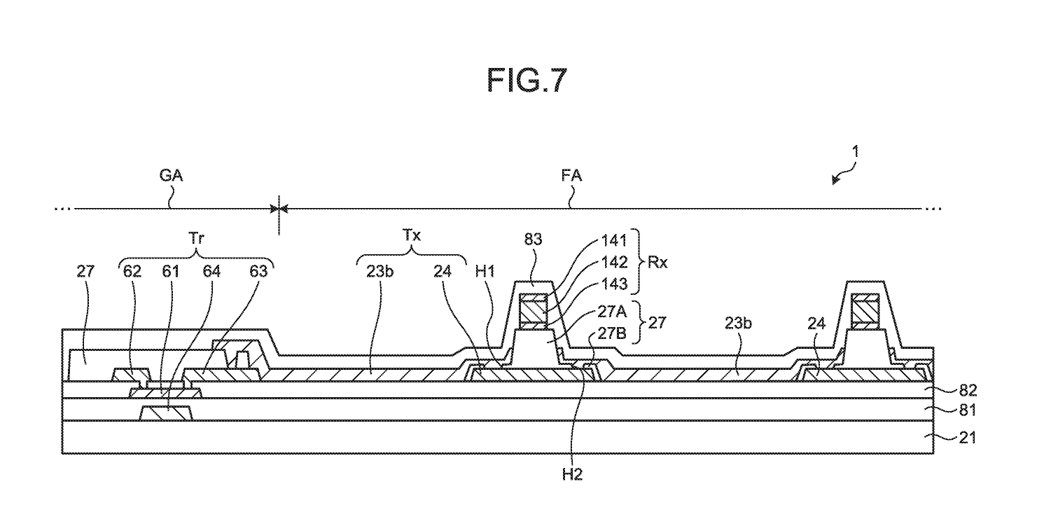

The following describes the configuration of the first electrodes Tx and the second electrodes Rx in the detection apparatus 1. FIG. 5 is a plan view of the detection apparatus according to the first embodiment. FIG. 6 is an enlarged plan view of part of the first electrodes and the second electrodes. FIG. 7 is a sectional view along line VII-VII′ in FIG. 6.

As illustrated in FIG. 5, the detection apparatus 1 includes a sensor substrate 21 and a plurality of first electrodes Tx and second electrodes Rx provided on the sensor substrate 21. The sensor substrate 21 is a translucent glass substrate that enables visible light to pass therethrough. Alternatively, the sensor substrate 21 may be a translucent resin substrate or resin film made of a resin, such as polyimide. The sensor 10 is a translucent sensor.

The first electrodes Tx extend in a first direction Dx and are arrayed in a second direction Dy. The second electrodes Rx extend in the second direction Dy and are arrayed in the first direction Dx. The second electrodes Rx extend in a direction intersecting the first electrodes Tx in planar view. The second electrodes Rx are coupled to a flexible printed circuit board 76 provided on a short side of the frame region GA on the sensor substrate 21 via frame wiring (not illustrated). The first electrodes Tx and the second electrodes Rx are provided in the detection region FA. The first electrodes Tx are made of a translucent conductive material, such as indium tin oxide (ITO). The second electrodes Rx are made of a metal material, such as aluminum or an aluminum alloy. Alternatively, the first electrodes Tx may be made of a metal material, and the second electrodes Rx may be made of ITO. The use of the second electrodes Rx made of a metal material can reduce resistance on the detection signals Vdet.

The first direction Dx is a direction in a plane parallel to the sensor substrate 21 and is a direction parallel to one side of the detection region FA, for example. The second direction Dy is a direction in a plane parallel to the sensor substrate 21 and is a direction orthogonal to the first direction Dx. The second direction Dy does not necessarily orthogonally intersect the first direction Dx. In the present specification, the “planar view” indicates a view seen in a direction perpendicular to the sensor substrate 21.

Capacitance is formed at the intersections of the second electrodes Rx and the first electrodes Tx. To perform a mutual capacitance touch detection operation, the first electrode selection circuit 15 selects a plurality of first electrodes Tx in the sensor 10 and supplies the first drive signals Vtx1 or the second drive signals Vtx2 simultaneously to the selected first electrodes Tx. The second electrodes Rx output the detection signals Vdet corresponding to changes in capacitance caused by unevenness on the surface of the finger or the like in contact with or in proximity to the detection apparatus 1. The detection apparatus 1 thus performs fingerprint detection. Alternatively, the second electrodes Rx output the detection signals Vdet corresponding to changes in capacitance caused by the finger or the like in contact with or in proximity to the detection apparatus 1. The detection apparatus 1 thus performs touch detection.

As illustrated in FIG. 5, various circuits, such as the first detection selection circuit 15 and the detection electrode selection circuit 16, are provided in the frame region GA on the sensor substrate 21. The first electrode selection circuit 15 includes a first selection circuit 151, a second selection circuit 152, a third selection circuit 153, and a first electrode block selection circuit 154. The configuration is given by way of example only. At least part of the various circuits may be included in a detection integrated circuit (IC) mounted on the flexible printed circuit board 76. Alternatively, at least part of the various circuits may be provided on an external control substrate. The first selection circuit 151, the second selection circuit 152, the third selection circuit 153, and the first electrode block selection circuit 154 are not necessarily provided as separated circuits. The first electrode selection circuit 15 may be provided as one integrated circuit having the functions of the first selection circuit 151, the second selection circuit 152, the third selection circuit 153, and the first electrode block selection circuit 154. The first electrode selection circuit 15 may be a semiconductor integrated circuit (IC).

The following describes the configuration of the first electrodes Tx and the second electrodes Rx. As illustrated in FIG. 6, the second electrode Rx is a zigzag line, and the long side of the second electrode Rx extends in the second direction Dy as a whole. The second electrode Rx includes a plurality of first linear portions 26a, a plurality of second linear portion 26b, and a plurality of bends 26x, for example. The second linear portions 26b extend in a direction intersecting the first linear portions 26a. The bend 26x couples the first linear portion 26a and the second linear portion 26b.

The first linear portion 26a extends in a direction intersecting the first direction Dx and the second direction Dy. The second linear portion 26b also extends in a direction intersecting the first direction Dx and the second direction Dy. The first linear portion 26a and the second linear portion 26b are disposed symmetrically about a virtual line (not illustrated) parallel to the first direction Dx. In the second electrode Rx, the first linear portions 26a and the second linear portions 26b are alternately coupled in the second direction Dy.

In each of the second electrodes Rx, Pry denotes an arrangement interval of the bends 26x in the second direction Dy. In the second electrodes Rx disposed side by side, Prx denotes an arrangement interval of the bends 26x in the first direction Dx. In the configuration according to the present embodiment, Prx<Pry is preferably satisfied, for example. The second electrode Rx does not necessarily have a zigzag shape and may have another shape, such as a wavy shape or a linear shape.

As illustrated in FIG. 6, a plurality of first electrodes Tx-1, Tx-2, Tx-3, Tx-4, . . . each include a plurality of electrode portions 23a or 23b and a plurality of couplers 24. In the following description, the first electrodes Tx-1, Tx-2, Tx-3, Tx-4, . . . are simply referred to as the first electrodes Tx when they need not be distinguished from one another.

The first electrodes Tx-1 and Tx-2 intersecting the second linear portions 26b of the second electrodes Rx include the electrode portions 23a having two sides parallel to the second linear portions 26b. The first electrodes Tx-3 and Tx-4 intersecting the first linear portions 26a of the second electrodes Rx include the electrode portions 23b having two sides parallel to the first linear portions 26a. In other words, a plurality of electrode portions 23a and 23b are disposed along the second electrodes Rx. This configuration can make the distances between the zigzag second electrodes Rx and the electrode portions 23a and 23b uniform in planar view.

In the first electrodes Tx-1 and Tx-2, the electrode portions 23a are arrayed in the first direction Dx and separated from each other. In each of the first electrodes Tx, the coupler 24 couples the electrode portions 23a disposed side by side out of the electrode portions 23a. Each of the second electrodes Rx extends through a space between the electrode portions 23a disposed side by side and intersect the couplers 24 in planar view. The first electrodes Tx-3 and Tx-4 also have the same configuration as described above. The second electrode Rx is a metal thin wire. The width of the second electrode Rx in the first direction Dx is smaller than that of the electrode portions 23a and 23b in the first direction Dx. This configuration reduces the area in which the first electrodes Tx and the second electrodes Rx overlap, thereby reducing stray capacitance.

Pt denotes an arrangement interval of the first electrodes Tx in the second direction Dy. The arrangement interval Pt is substantially one-half the arrangement interval Pry of the bends 26x of the second electrodes Rx. The configuration is not limited thereto, and the arrangement interval Pt may be other than a half-integer multiple of the arrangement interval Pry. The arrangement interval Pt is 50 μm to 100 μm, for example. In one first electrode Tx, the couplers 24 disposed side by side in the first direction Dx are alternately disposed with an arrangement interval Pb interposed therebetween in the second direction Dy. While the electrode portions 23a and 23b have a parallelogram shape, they may have another shape. The electrode portions 23a and 23b may have a rectangular, polygonal, or deformed shape, for example.

The following describes the layer structure of the detection apparatus 1 with reference to FIG. 7. In FIG. 7, the section of the frame region GA is a section of a portion including a thin-film transistor Tr in the first electrode selection circuit 15. To explain the relation between the layer structure of the detection region FA and that of the frame region GA, FIG. 7 schematically illustrates the section along line VII-VII′ in the detection region FA and the section of the portion including the thin-film transistor Tr in the frame region GA in a continuous manner.

As illustrated in FIG. 7, the detection apparatus 1 includes the thin-film transistors Tr in the frame region GA. The thin-film transistor Tr includes a semiconductor layer 61, a source electrode 62, a drain electrode 63, and a gate electrode 64. The gate electrode 64 is provided on the sensor substrate 21. A first interlayer insulating film 81 is provided on the sensor substrate 21 to cover the gate electrode 64. The gate electrode 64 is made of aluminum (Al), copper (Cu), silver (Ag), molybdenum (Mo), or an alloy of these metals. The first interlayer insulating film 81 is made of a silicon oxide film (SiO), a silicon nitride film (SiN), or a silicon oxynitride film (SiON). The first interlayer insulating film 81 is not necessarily a single layer and may be a multilayered film. The first interlayer insulating film 81, for example, may be a multilayered film in which a silicon nitride film is formed on a silicon oxide film.

The semiconductor layer 61 is provided on the first interlayer insulating film 81. A second interlayer insulating film 82 is provided on the first interlayer insulating film 81 to cover the semiconductor layer 61. The semiconductor layer 61 is exposed on the bottom of a contact hole formed in the second interlayer insulating film 82. The semiconductor layer 61 is made of polysilicon or an oxide semiconductor. The second interlayer insulating film 82 is made of a silicon oxide film, a silicon nitride film, or a silicon oxynitride film. The second interlayer insulating film 82 is not necessarily a single layer and may be a multilayered film. The second interlayer insulating film 82, for example, may be a multilayered film in which a silicon nitride film is formed on a silicon oxide film.

The source electrode 62 and the drain electrode 63 are provided on the second interlayer insulating film 82. The source electrode 62 and the drain electrode 63 are coupled to the semiconductor layer 61 through the contact hole formed in the second interlayer insulating film 82. The source electrode 62, the drain electrode 63, and the coupler 24 are made of titanium-aluminum (TiAl), which is an alloy of titanium and aluminum.

An insulating resin layer 27 and the electrode portion 23b and the coupler 24 of the first electrode Tx are provided on the second interlayer insulating film 82. The resin layer 27 provided in the frame region GA covers the source electrode 62 and the drain electrode 63. The drain electrode 63 is electrically coupled to the first electrode Tx through a contact hole formed in the resin layer 27 provided in the frame region GA.

The resin layer 27 provided in the detection region FA includes a first resin layer 27A and a second resin layer 27B thinner than the first resin layer 27A. The first resin layer 27A covers a portion of the coupler 24 positioned just under the second electrode Rx. The second resin layer 27B provided in the detection region FA covers a portion of the coupler 24 positioned just under the electrode portion 23b.

The second resin layer 27B has contact holes H1 and H2. In the detection region FA, peripheries of the electrode portions 23b are coupled to the coupler 24 through the contact holes H1 and H2. In this example, the electrode portion 23b is in contact with the second interlayer insulating film 82.

The second electrode Rx is provided on the first resin layer 27A. The second electrode Rx includes a first metal layer 141, a second metal layer 142, and a third metal layer 143, for example. The second metal layer 142 is provided on the third metal layer 143, and the first metal layer 141 is provided on the second metal layer 142. The first metal layer 141 and the third metal layer 143 are made of molybdenum or a molybdenum alloy, for example. The second metal layer 142 is made of aluminum or an aluminum alloy, for example. Molybdenum or a molybdenum alloy included in the first metal layer 141 has reflectance of visible light lower than that of aluminum or an aluminum alloy included in the second metal layer 142. This structure can prevent the second electrode Rx from being visually recognized.

An insulating film 83 is provided on the resin layer 27, the electrode portion 23b, and the second electrode Rx. The insulating film 83 covers the upper surface and the side surfaces of the second electrode Rx. The insulating film 83 is a film having a high refractive index and low reflectance, such as a silicon nitride film.

With the configuration described above, the first electrodes Tx and the second electrodes Rx are provided on the single sensor substrate 21. The first electrodes Tx and the second electrodes Rx are provided in different layers with the resin layers 27 serving as insulating layers interposed therebetween.

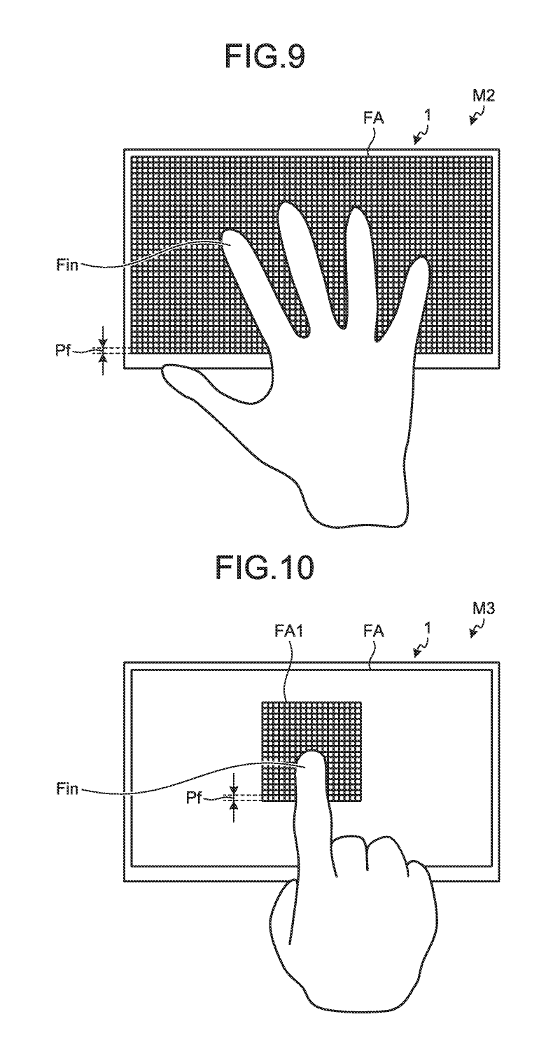

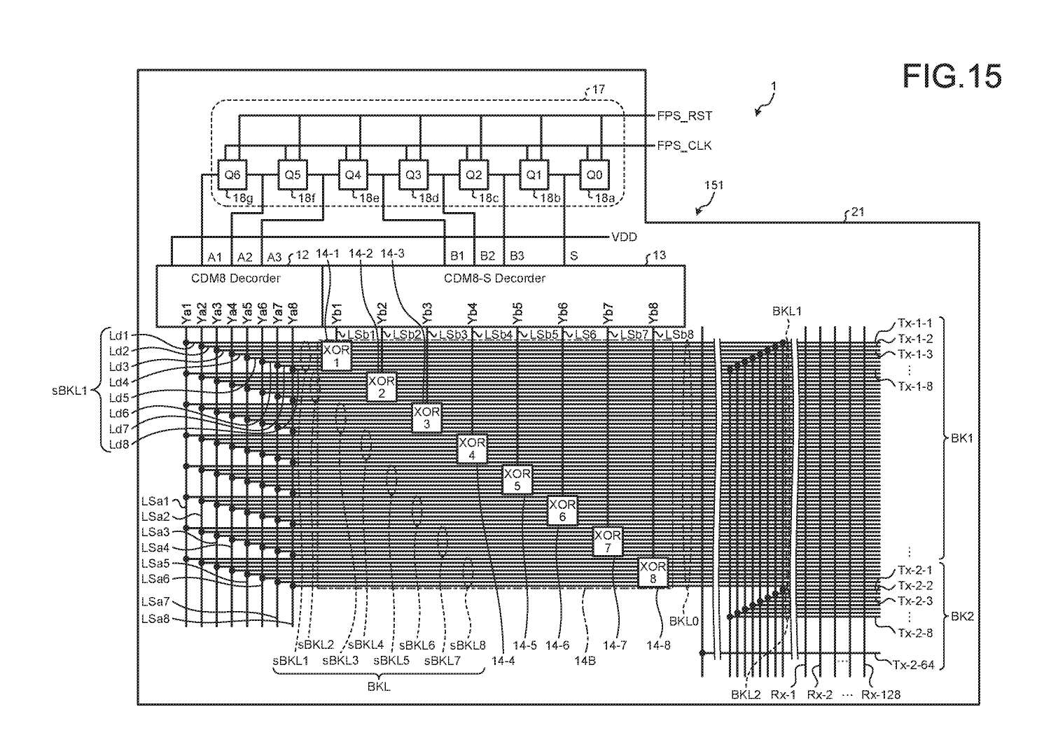

The following describes various detection modes of the detection apparatus 1. FIG. 8 is a view for explaining the first detection mode of the detection apparatus according to the first embodiment. As illustrated in FIG. 8, in the first detection mode M1, the detection apparatus 1 scans the whole surface of the detection region FA at a first detection pitch Pts larger than the pitch in the second detection mode M2 (refer to FIG. 9), thereby detecting the finger Fin or the like. In the first detection mode M1, the first electrode selection circuit 15 collectively selects a plurality of first electrodes Tx and supplies the first drive signals Vtx1 to the respective first electrode blocks BK (refer to FIG. 15). At least the first electrodes Tx included in one first electrode block BK are supplied with the same first drive signal Vtx1. As a result, in the first detection mode M1, the detection apparatus 1 can perform detection at the first detection pitch Pts larger than the pitch in the second detection mode M2, which will be described later. In the first detection mode M1, for example, the detection apparatus 1 can detect a touch made by the finger Fin or the like. In the first detection mode M1, the detection apparatus 1 may perform touch detection in units of the first electrode block BK by CDM drive or TDM drive.

FIG. 9 is a view for explaining the second detection mode of the detection apparatus according to the first embodiment. As illustrated in FIG. 9, in the second detection mode M2, the detection apparatus 1 scans the whole surface of the detection region FA at a second detection pitch Pf smaller than the pitch in the first detection mode M1 (refer to FIG. 8), thereby detecting the finger Fin or the like. In the second detection mode M2, the first electrode selection circuit 15 supplies the second drive signals Vtx2 having the phases determined based on a predetermined code to the respective first electrodes Tx. As a result, in the second detection mode M2, the detection apparatus 1 can perform detection at the second detection pitch Pf smaller than the pitch in the first detection mode M1. In the second detection mode M2, for example, the detection apparatus 1 can detect the fingerprint of the finger Fin or the like by performing CDM drive.

In the second detection mode M2, the detection apparatus 1 performs detection on the whole surface of the detection region FA. Consequently, the detection apparatus 1 can detect not only a fingerprint but also a palm print, for example. Alternatively, the detection apparatus 1 can detect the shape of a hand in contact with or in proximity to the detection region FA and determine the position of a fingertip. In this case, the detection apparatus 1 can detect the fingerprint by performing signal processing and arithmetic processing on only the region with or to which the fingertip is in contact or in proximity.

FIG. 10 is a view for explaining the third detection mode of the detection apparatus according to the first embodiment. As illustrated in FIG. 10, in the third detection mode M3, the detection apparatus 1 performs detection at the second detection pitch Pf in a first partial region FA1, which is part of the detection region FA. In the third detection mode M3, the first electrode selection circuit 15 supplies the second drive signals Vtx2 having the phases determined based on a predetermined code to the respective first electrodes Tx included in the first partial region FA1. Also in the third detection mode M3, the detection apparatus 1 can perform detection at the second detection pitch Pf. In the third detection mode M3, for example, the detection apparatus 1 can detect the fingerprint of the finger Fin or the like by performing CDM drive. Performing detection on only the first partial region FA1 can reduce the time required for detection and the amount of processing performed by the detector 40 (refer to FIG. 3). The first partial region FA1 is a fixed region determined in advance. The position and the size of the first partial region FA1 may be appropriately modified.

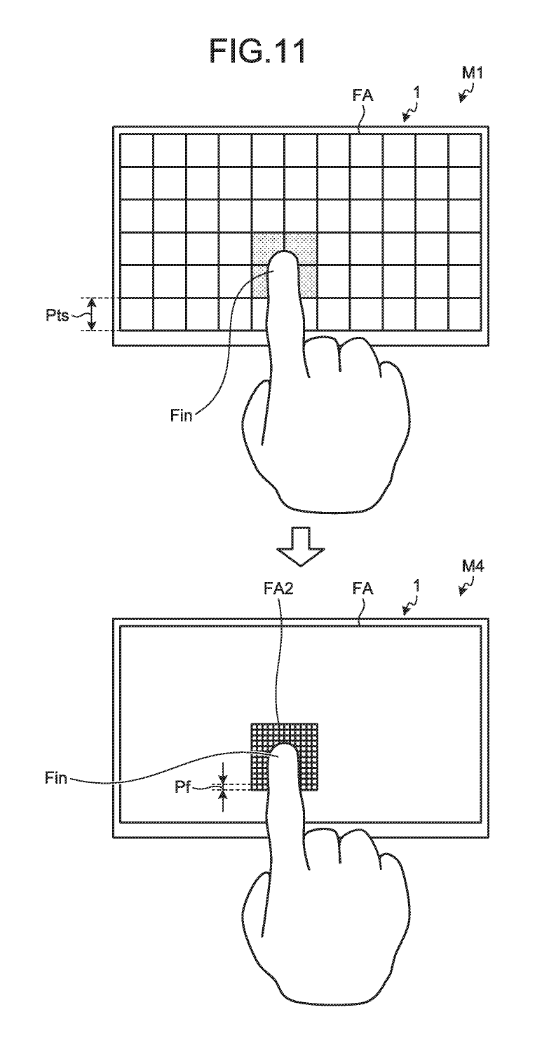

FIG. 11 is a view for explaining the fourth detection mode of the detection apparatus according to the first embodiment. As illustrated in FIG. 11, the detection apparatus 1 performs touch detection in the first detection mode M1 to detect the finger Fin or the like in contact with or in proximity to the detection region FA. If the finger Fin or the like is detected, the detection apparatus 1 performs detection in the fourth detection mode M4. In detection in the fourth detection mode M4, the detection apparatus 1 performs detection at the second detection pitch Pf in a second partial region FA2 overlapping the position where the finger Fin or the like is detected. In the fourth detection mode M4, for example, the detection apparatus 1 detects the fingerprint of the finger Fin or the like by CDM drive. The position and the size of the second partial region FA2 can be modified based on information on the detected finger Fin or the like. As described above, the detection apparatus 1 may perform fingerprint detection in the fourth detection mode M4 based on the detection results in the first detection mode M1. This mechanism can reduce the area of the second partial region FA2, thereby reducing the time required for detection.

The detection apparatus 1 may switch the detection modes in response to an operation of selecting the detection mode performed by an operator, for example. Alternatively, the detection apparatus 1 may perform the detection modes in respective predetermined periods in a time-division manner. Still alternatively, the detection apparatus 1 does not necessarily perform any one of the first detection mode M1 to the fourth detection mode M4.

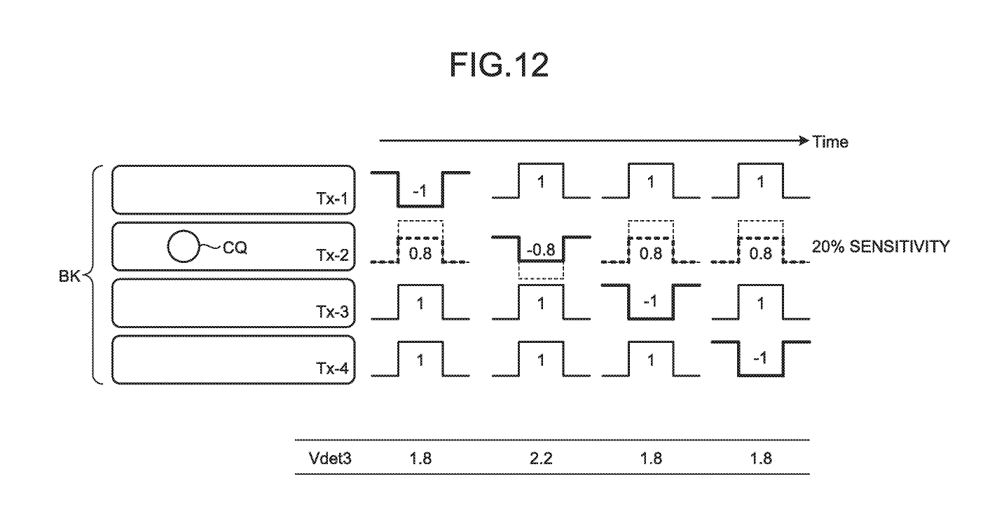

The following describes CDM drive performed by the detection apparatus 1. FIG. 12 is a diagram for explaining an exemplary operation in code division multiplexing drive. To simplify the explanation, FIG. 12 illustrates an exemplary operation in CDM drive performed on four first electrodes Tx-1, Tx-2, Tx-3, and Tx-4. As illustrated in FIG. 12, the first electrode selection circuit 15 (refer to FIG. 3) selects the four first electrodes Tx-1, Tx-2, Tx-3, and Tx-4 of one first electrode block BK simultaneously. The first electrode selection circuit 15 supplies the second drive signals Vtx2 having the phases determined based on a predetermined code to the respective first electrodes Tx. The predetermined code is defined by the square matrix in Expression (1), for example. The order of the square matrix is four, which is equal to the number of first electrodes Tx-1, Tx-2, Tx-3, and Tx-4. Diagonal elements “−1” of the square matrix in Expression (1) are different from elements “1” other than the diagonal elements of the square matrix. The first electrode selection circuit 15 applies the second drive signals Vtx2 such that the phase of AC rectangular waves corresponding to the elements “1” other than the diagonal elements of the square matrix is opposite to the phase of AC rectangular waves corresponding to the diagonal elements “−1” of the square matrix based on the square matrix in Expression (1). The element “−1” is an element for supplying the second drive signal Vtx2 determined to have a phase different from that of the element “1”.

$$( \begin{matrix}- 1 & 1 & 1 & 1 \\ 1 & - 1 & 1 & 1 \\ 1 & 1 & - 1 & 1 \\ 1 & 1 & 1 & - 1\end{matrix} ) ( \begin{matrix}1.8 \\ 2.2 \\ 1.8 \\ 1.8\end{matrix} ) = ( \begin{matrix}4.0 \\ 3.2 \\ 4.0 \\ 4.0\end{matrix} ) \qquad ( 1 )$$

If an external proximity object CQ, such as a finger, is present on the first electrode Tx-2 out of the first electrodes Tx-1, Tx-2, Tx-3, and Tx-4, a voltage of difference due to the external proximity object CQ is generated by mutual induction (the voltage of difference is 20%, for example). In the example illustrated in FIG. 12, the third detection signal Vdet3, which is obtained by integrating the first detection signal Vdet1 corresponding to the element “1” and the second detection signal Vdet2 corresponding to the element “−1”, is output from the second electrode Rx. The third detection signal Vdet3 detected by the detector 40 in the first period of time is calculated by: (−1)+(0.8)+(1)+(1)=1.8. The third detection signal Vdet3 in the second period of time is calculated by: (1)+(−0.8)+(1)+(1)=2.2. The third detection signal Vdet3 in the third period of time is calculated by: (1)+(0.8)+(−1)+(1)=1.8. The third detection signal Vdet3 in the fourth period of time is calculated by: (1)+(0.8)+(1)+(−1)=1.8.

The signal processor 44 stores the third detection signals Vdet3 detected in the respective periods of time in the storage 46. The signal processor 44 multiplies the third detection signals Vdet3 by the square matrix in Expression (1), thereby performing decoding. As a result, the signal processor 44 calculates Vdet4=“4.0, 3.2, 4.0, 4.0” as a decoded signal Vdet4. The detector 40 can detect the presence of the external proximity object CQ, such as a finger, or unevenness on the surface of the external proximity object CQ at the position of the first electrode Tx-2 based on the decoded signal Vdet4. As described above, the detection apparatus 1 performs detection with detection sensitivity four times the detection sensitivity in time division multiplexing (TDM) drive without raising the voltage. The coordinate extractor 45 outputs the touch panel coordinates or the decoded signal Vdet4 as the sensor output Vo.

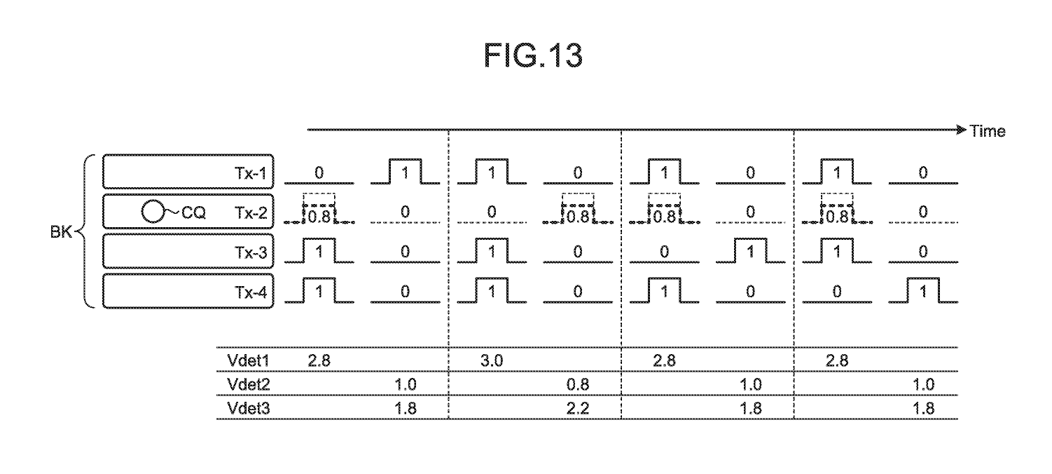

FIG. 13 is a diagram for explaining another exemplary operation in code division multiplexing drive. In FIG. 13, the second drive signals Vtx2 are applied to the first electrodes Tx corresponding to the elements “1” of the square matrix and the first electrodes Tx corresponding to the elements “−1” of the square matrix in different periods of time. In this case, the phase of the AC rectangular waves corresponding to the elements “1” of the square matrix is the same as that of the AC rectangular waves corresponding to the elements “−1” of the square matrix. Specifically, in the first, the third, the fifth, and the seventh periods of time, the first electrode selection circuit 15 supplies the second drive signals Vtx2 to the first electrodes Tx corresponding to the elements “1”. In the periods of time described above, the first electrode selection circuit 15 supplies no second drive signal Vtx2 to the first electrodes Tx corresponding to the elements “−1”. By contrast, in the second, the fourth, the sixth, and the eighth periods of time, the first electrode selection circuit 15 supplies no second drive signal Vtx2 to the first electrodes Tx corresponding to the elements “1” but supplies the second drive signals Vtx2 to the first electrodes Tx corresponding to the elements “−1”.

The signal processor 44 calculates the difference between the first detection signal Vdet1=2.8 detected in the first period of time and the second detection signal Vdet2=1.0 detected in the second period of time as the third detection signal Vdet3=1.8. The signal processor 44 calculates the difference between the first detection signal Vdet1=3.0 detected in the third period of time and the second detection signal Vdet2=0.8 detected in the fourth period of time as the third detection signal Vdet3=2.2. The signal processor 44 performs the same operation as described above in and after the fifth period of time. The signal processor 44 decodes the calculated third detection signals Vdet3, thereby calculating Vdet4=“4.0, 3.2, 4.0, 4.0” as the decoded signal Vdet4.

If several hundred to one thousand or more first electrodes Tx are provided at a small array pitch, for example, the size of the circuits that supply the selection signals and the drive signals resulting from the predetermined code may possibly increase. In a method of sequentially transmitting the selection signals to the first electrodes Tx via shift registers or the like, the detection performance may possibly be degraded because of delay of the signals, for example. The first electrode selection circuit 15 according to the present embodiment includes the circuits that generate the signals having the phases determined based on the predetermined code simultaneously in parallel. This configuration can suppress an increase in circuit size and enable satisfactory fingerprint detection and touch detection.

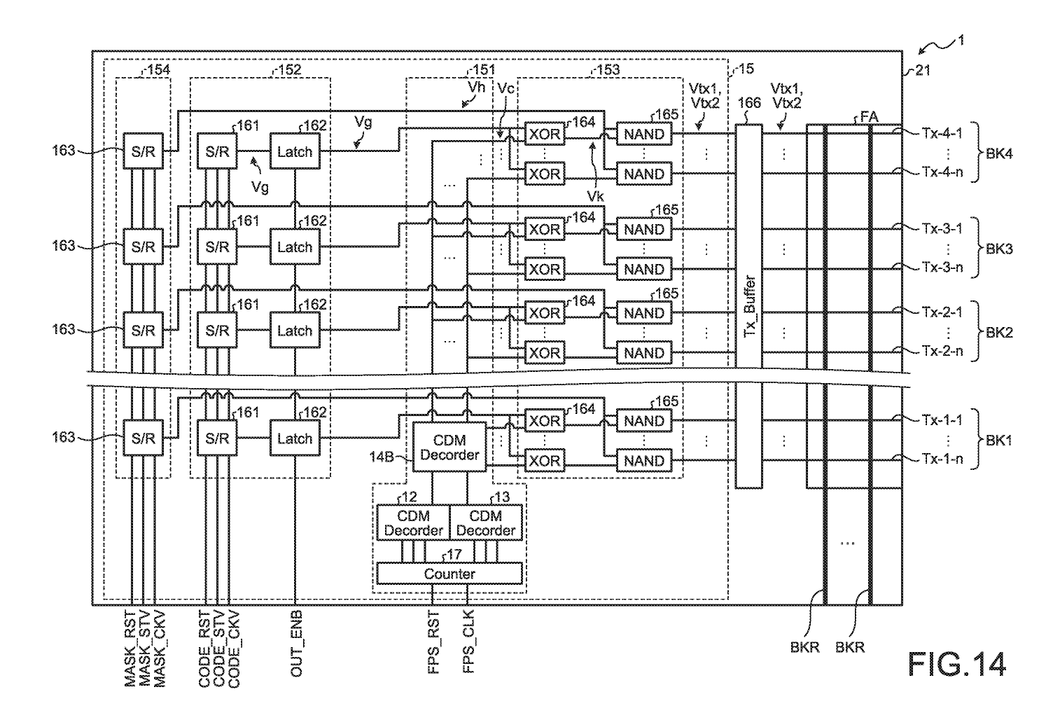

The following describes the configuration of the first electrode selection circuit 15. FIG. 14 is a block diagram of the first electrode selection circuit according to the first embodiment. As illustrated in FIG. 14, the first electrode selection circuit 15 includes the first selection circuit 151, the second selection circuit 152, the third selection circuit 153, and the first electrode block selection circuit 154. In FIG. 14, the detection apparatus 1 includes four first electrode blocks BK1, BK2, BK3, and BK4. The first electrode blocks BK1, BK2, BK3, and BK4 each include a plurality of first electrodes Tx (e.g., 64 first electrodes Tx-1 to Tx-64) (refer to FIG. 15). In the following description, the first electrode blocks BK1, BK2, BK3, and BK4 are referred to as the first electrode blocks BK when they need not be distinguished from one another. The detection apparatus 1 may include five or more first electrode blocks BK, for example.

The first selection circuit 151 provides first selection signals Vc having the phases determined based on a predetermined code for the respective first electrodes Tx. The first selection circuit 151 includes a third code generation circuit block 14B provided for the respective first electrode blocks BK. The second selection circuit 152 supplies second selection signals Vg having the phases determined based on a predetermined code for the respective first electrode blocks BK. The third selection circuit 153 provides third selection signals Vk based on the first selection signals Vc and the second selection signals Vg. The first electrode block selection circuit 154 generates first electrode block selection signals Vh for selecting the first electrode blocks BK. The third selection circuit 153 supplies the first drive signals Vtx1 or the second drive signals Vtx2 to the respective first electrodes Tx included in the selected first electrode blocks BK based on the first electrode block selection signals Vh and the third selection signals Vk.

FIG. 15 is a block diagram of the first selection circuit of the first electrode selection circuit. To simplify the explanation, the following describes one first electrode block BK with reference to FIG. 15. As illustrated in FIGS. 14 and 15, the first selection circuit 151 includes a first code generation circuit 12, a second code generation circuit 13, a third code generation circuit 14, and a counter circuit 17. The first selection signals Vc, which are not illustrated in FIG. 15, output from the third code generation circuit 14 are supplied to the first electrodes Tx via the third selection circuit 153 and a buffer 166 as illustrated in FIG. 14.

The first code generation circuit 12 and the second code generation circuit 13 are decoder circuits. The first code generation circuit 12 generates first partial selection signals Vd based on first control signals Va1, Va2, and Va3 and supplies the first partial selection signals Vd to the third code generation circuit 14. The second code generation circuit 13 generates second partial selection signals Vf based on second control signals Vb1, Vb2, and Vb3 and supplies the second partial selection signals Vf to the third code generation circuit 14. The third code generation circuit 14 is an exclusive OR (XOR) circuit, for example. The third code generation circuit 14 provides the first selection signals Vc based on the first partial selection signals Vd and the second partial selection signals Vf and supplies signals resulting from the first selection signals Vc to the first electrodes Tx. The counter circuit 17 generates the first control signals Va1, Va2, and Va3, the second control signals Vb1, Vb2, and Vb3, and an inversion control signal Vs based on a first reset signal FPS_RST and a first clock signal FPS_CLK supplied from the detection controller 11 (refer to FIG. 3).

As illustrated in FIG. 15, the first code generation circuit 12, the second code generation circuit 13, the third code generation circuit 14, and the counter circuit 17 are provided on the sensor substrate 21. The first code generation circuit 12 includes first input terminals A1, A2, and A3, a power source voltage terminal VDD, and first output terminals Ya1, Ya2, Ya3, Ya4, Ya5, Ya6, Ya7, and Ya8. In the following description, the first output terminals Ya1, Ya2, Ya3, Ya4, Ya5, Ya6, Ya7, and Ya8 are simply referred to as first output terminals Ya when they need not be distinguished from one another. In the configuration according to the present embodiment, the number P of first output terminals Ya serving as output terminals of the first code generation circuit 12 is eight. The first input terminals A1, A2, and A3 receive the first control signals Va1, Va2, and Va3, respectively, from the counter circuit 17. The first code generation circuit 12 generates the first partial selection signals Vd based on the first control signals Va1, Va2, and Va3. The first output terminals Ya output the first partial selection signals Vd to respective first selection signal lines LSa1, LSa2, . . . , and LSa8.

The second code generation circuit 13 includes second input terminals B1, B2, B3, and S and second output terminals Yb1, Yb2, Yb3, Yb4, Yb5, Yb6, Yb7, and Yb8. In the following description, the second output terminals Yb1, Yb2, Yb3, Yb4, Yb5, Yb6, Yb7, and Yb8 are simply referred to as second output terminals Yb when they need not be distinguished from one another. In the configuration according to the present embodiment, the number Q of second output terminals Yb serving as output terminals of the second code generation circuit 13 is eight. The second input terminals B1, B2, and B3 receive the second control signals Vb1, Vb2, and Vb3, respectively, from the counter circuit 17. The second input terminal S receives the inversion control signal Vs from the counter circuit 17. The second code generation circuit 13 generates the second partial selection signals Vf based on the second control signals Vb1, Vb2, and Vb3 and the inversion control signal Vs. The inversion control signal Vs is a signal for inverting the elements “1” and “−1” of the predetermined code. The second output terminals Yb output the second partial selection signals Vf to respective second selection signal lines LSb1, LSb2, . . . , and LSb8.

As illustrated in FIG. 15, a plurality of first electrode blocks BK each including a plurality of first electrodes Tx-1, Tx-2, Tx-3, . . . , and Tx-64 are provided. In the configuration according to the present embodiment, the number N of first electrodes Tx included in one first electrode block BK is 64. Drive signal supply lines Ld1, Ld2, . . . , and Ld64 are coupled to the respective first electrodes Tx. Drive signal supply line partial blocks sBKL1, sBKL2, sBKL3, sBKL4, sBKL5, sBKL6, sBKL7, and sBKL8 each include eight drive signal supply lines Ld the number of which corresponds to the number Q of second output terminals Yb. The first electrode block BK is coupled to a drive signal supply line block BKL. The drive signal supply line block BKL includes eight drive signal supply line partial blocks sBKL the number of which corresponds to the number Q of second output terminals Yb.

The first selection signal lines LSa1, LSa2, . . . , and LSa8 are coupled to the respective drive signal supply lines Ld in each of the drive signal supply line partial blocks sBKL. As a result, the first selection signal lines LSa1, LSa2, . . . , and LSa8 are coupled to the drive signal supply line partial blocks sBKL1, sBKL2, sBKL3, sBKL4, sBKL5, sBKL6, sBKL7, and sBKL8 in parallel. The first selection signal lines LSa1, LSa2, . . . , and LSa8 are coupled to different drive signal supply lines Ld. In other words, the drive signal supply lines Ld included in one drive signal supply line partial block sBKL are coupled to the respective first selection signal lines LSa1, LSa2, . . . , and LSa8. The drive signal supply lines Ld1, Ld2, . . . , and Ld8 included in the drive signal supply line partial block sBKL1, for example, are coupled to the first selection signal lines LSa1, LSa2, . . . , and LSa8, respectively. The drive signal supply line partial blocks sBKL2, sBKL3, . . . , and sBKL8 have the same configuration as described above.

Third code generation circuits 14-1, 14-2, . . . , and 14-8 included in the third code generation circuit block 14B are provided corresponding to the drive signal supply line partial blocks sBKL1, sBKL2, sBKL3, . . . , and sBKL8, respectively. In other words, in the first electrode blocks BK disposed side by side, the first electrodes Tx included in respective the first electrode blocks and disposed at the same position in the direction in which the first electrode blocks BK are disposed side by side are coupled to the third code generation circuit 14 coupled to the same second selection signal line LSb. The second selection signal lines LSb1, LSb2, . . . , and LSb8 are coupled to the third code generation circuits 14-1, 14-2, . . . , and 14-8, respectively. In other words, the second selection signal lines LSb1, LSb2, . . . , and LSb8 are coupled to the drive signal supply line partial blocks sBKL1, sBKL2, . . . , and sBKL8, respectively. To simplify the explanation, the third code generation circuit block 14B illustrated in FIG. 15 are divided into the third code generation circuits 14-1, 14-2, . . . , and 14-8 corresponding to the respective drive signal supply line partial blocks sBKL. The third code generation circuits 14-1, 14-2, . . . , and 14-8 may be provided as one circuit. A drive signal supply line block BKL0 corresponds to a plurality of drive signal supply line partial blocks sBKL. The drive signal supply line block BKL0 is coupled to a plurality of drive signal supply line blocks BKL1, BKL2, . . . , and BKLn. The drive signal supply line blocks BKL1, BKL2, . . . , and BKLn correspond to the first electrode blocks BK1, . . . , and BKn, respectively. With this configuration, the third code generation circuit block 14B outputs the same signals to the first electrode blocks BK.

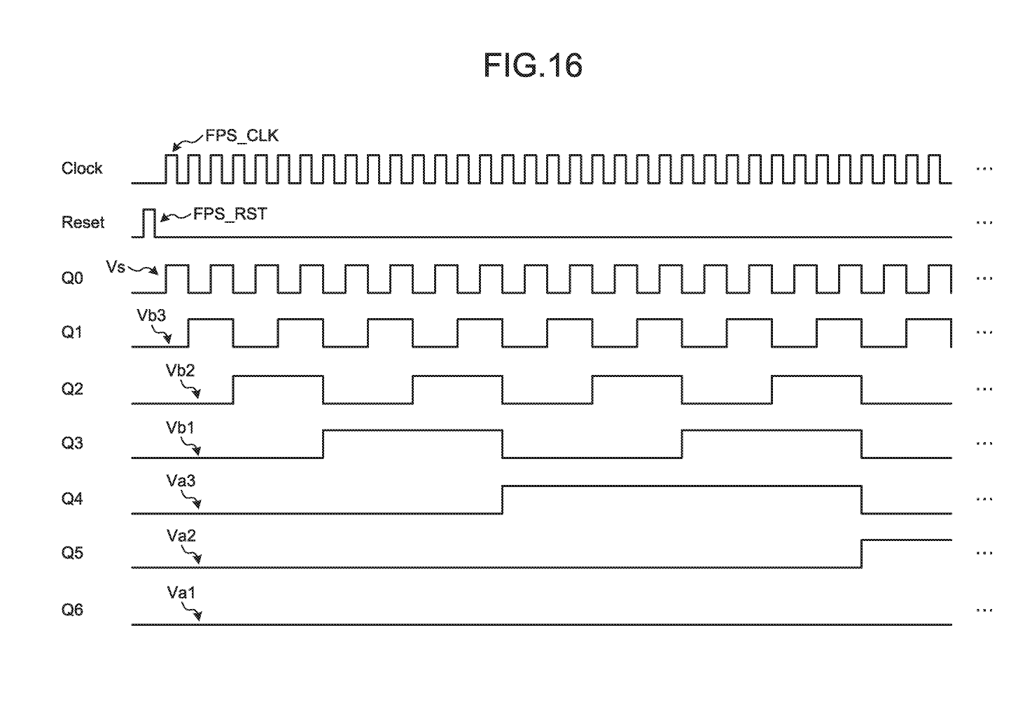

The following describes the operations performed by the counter circuit 17, the first code generation circuit 12, the second code generation circuit 13, and the third code generation circuit 14. FIG. 16 is a timing waveform chart of an exemplary operation performed by the counter circuit. The counter circuit 17 illustrated in FIG. 15 is a binary counter circuit, for example, and outputs binary numbers. The counter circuit 17 includes a plurality of flip-flop circuits 18a, 18b, 18c, 18d, 18e, 18f, and 18g. The flip-flop circuits 18a, 18b, 18c, 18d, 18e, 18f, and 18g are registers that can hold one-bit information. In the following description, the flip-flop circuits 18a, 18b, 18c, 18d, 18e, 18f, and 18g are simply referred to as flip-flop circuits 18 when they need not be distinguished from one another. While the counter circuit 17 is provided on the sensor substrate 21, the configuration is not limited thereto. The counter circuit 17 may be provided in the detection controller 11 or an external control substrate.

As illustrated in FIGS. 15 and 16, an output signal from the flip-flop circuit 18a is supplied to the second input terminal S of the second code generation circuit 13 as the inversion control signal Vs. The output signal from the flip-flop circuit 18a is also output to the next flip-flop circuit 18b. The frequency of the inversion control signal Vs is one half the frequency of the first clock signal FPS_CLK. An output signal from the flip-flop circuit 18b at the second stage is supplied to the second input terminal B3 of the second code generation circuit 13 as the second control signal Vb3. The output signal from the flip-flop circuit 18b is also output to the next flip-flop circuit 18c. The frequency of the second control signal Vb3 is one half the frequency of the inversion control signal Vs. Similarly, the flip-flop circuits 18c, 18d, 18e, 18f, and 18g output the second control signals Vb2 and Vb1 and the first control signals Va3, Va2, and Va1, respectively.

If the state of all the flip-flop circuits 18 is “1”, the flip-flop circuits 18 are reset to “0” based on the first reset signal FPS_RST.

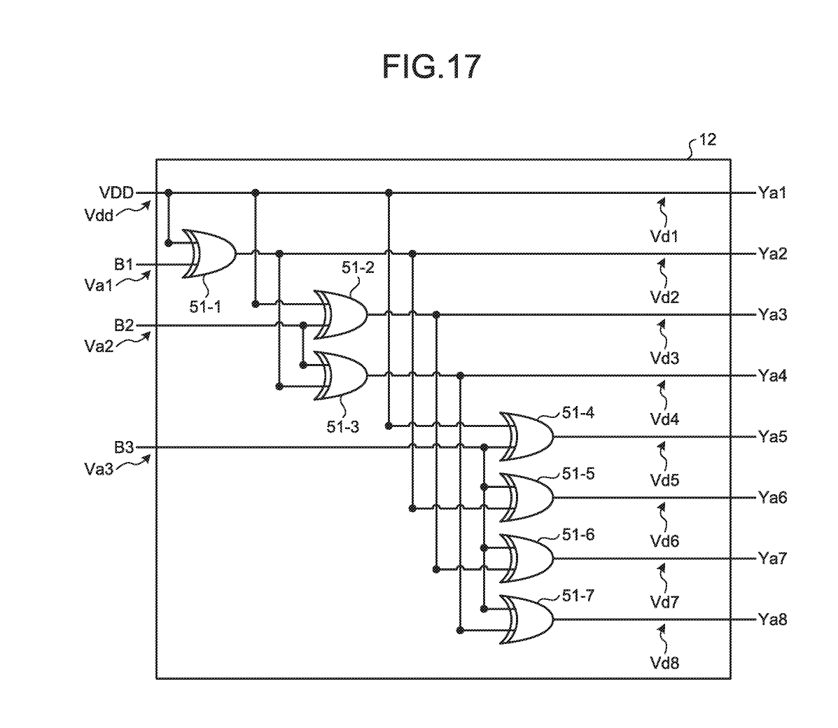

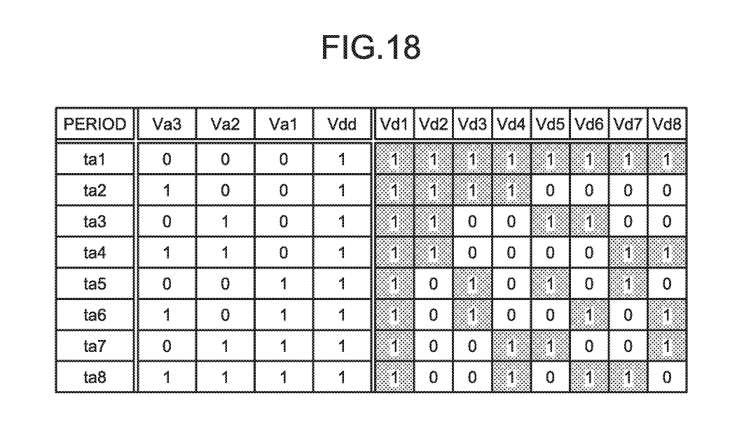

FIG. 17 is a circuit diagram of an example of the first code generation circuit. FIG. 18 is a table indicating the relation between the first control signals and the first partial selection signals. As illustrated in FIG. 17, the first code generation circuit 12 includes a plurality of XOR circuits 51-1, 51-2, . . . , and 51-7. The XOR circuits 51-1, 51-2, . . . , and 51-7 receive any one of the first control signals Va1, Va2, and Va3 and the power source voltage Vdd or an output signal from another XOR circuit 51. The first control signals Va1, Va2, and Va3 are output signals from the counter circuit 17 illustrated in FIG. 15. The XOR circuits 51-1, 51-2, . . . , and 51-7 output the value of exclusive or (Xor) of the received signals as first partial selection signals Vd2, Vd3, . . . , and Vd8, respectively. The same signal as the power source voltage Vdd is output as a first partial selection signal Vd1.

The first code generation circuit 12 generates the first partial selection signals Vd1, Vd2, . . . , and Vd8 corresponding to the first control signals Va1, Va2, and Va3 and the power source voltage Vdd according to the truth table illustrated in FIG. 18. In FIG. 18, “1” is allocated if the signals are at a high-level voltage, and “0” is allocated if the signals are at a low-level voltage. The first code generation circuit 12 thus outputs the first partial selection signals Vd1, Vd2, and Vd8 having the phases determined based on a predetermined code to the drive signal supply line partial blocks sBKL. The predetermined code is defined by the square matrix in Expression (2), for example. The order of the square matrix is eight, which is equal to the number of first output terminals Ya. The predetermined code is a square matrix the elements of which are either “1” or “−1” or “1” or “0” and certain two different rows of which are an orthogonal matrix. The predetermined code is based on a Hadamard matrix, for example.

$$( \begin{matrix}1 & 1 & 1 & 1 & 1 & 1 & 1 & 1 \\ 1 & 1 & 1 & 1 & - 1 & - 1 & - 1 & - 1 \\ 1 & 1 & - 1 & - 1 & 1 & 1 & - 1 & - 1 \\ 1 & 1 & - 1 & - 1 & - 1 & - 1 & 1 & 1 \\ 1 & - 1 & 1 & - 1 & 1 & - 1 & 1 & - 1 \\ 1 & - 1 & 1 & - 1 & - 1 & 1 & - 1 & 1 \\ 1 & - 1 & - 1 & 1 & 1 & - 1 & - 1 & 1 \\ 1 & - 1 & - 1 & 1 & - 1 & 1 & 1 & - 1\end{matrix} ) \qquad ( 2 )$$

The first code generation circuit 12 outputs the first partial selection signals Vd1, Vd2, . . . , and Vd8 from the respective first output terminals Ya in each of periods ta1, ta2, . . . , and ta8. The combination patterns of turning-on and -off of the first partial selection signals Vd1, Vd2, . . . , and Vd8 are different from one another between the periods ta1, ta2, . . . , and ta8. The number of combination patterns of turning-on and -off of the first partial selection signals Vd1, Vd2, . . . , and Vd8 is eight, which is equal to the number of first output terminals Ya.

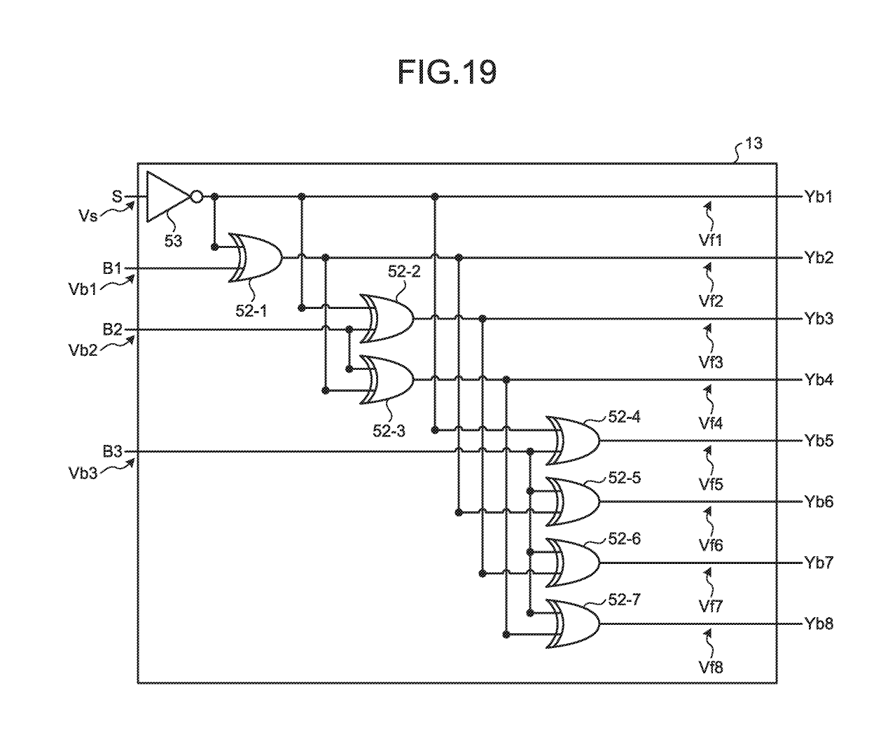

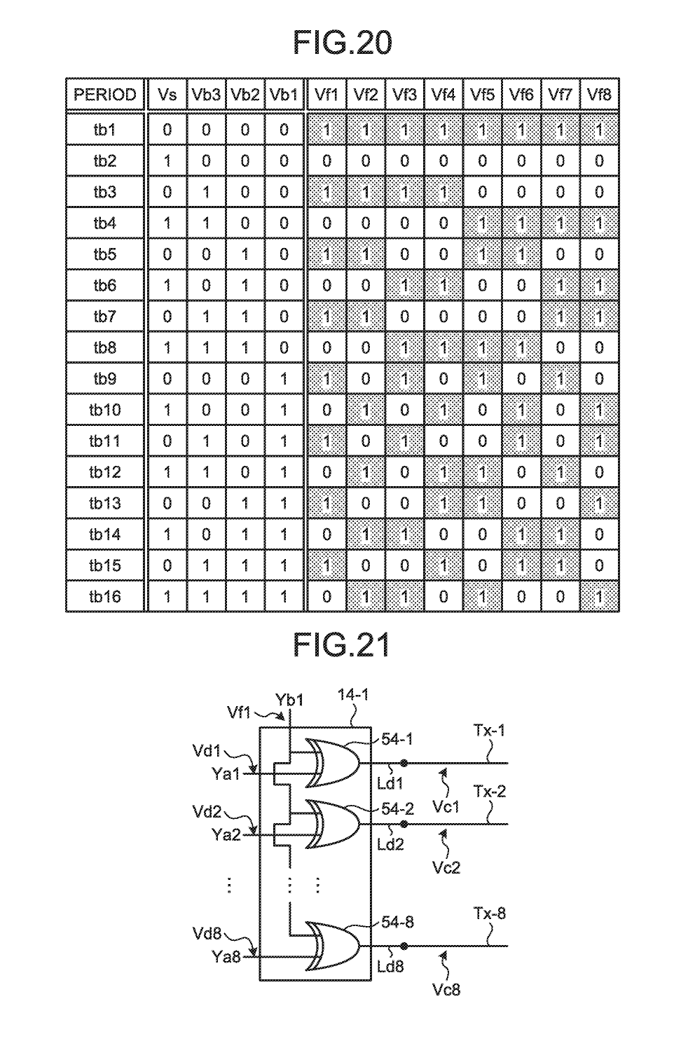

FIG. 19 is a circuit diagram of an example of the second code generation circuit. FIG. 20 is a table indicating the relation between the second control signals and the inversion control signal, and the second partial selection signals. As illustrated in FIG. 19, the second code generation circuit 13 includes a plurality of XOR circuits 52-1, 52-2, . . . , and 52-7 and an inverter 53. The inverter 53 outputs a voltage signal obtained by inverting the inversion control signal Vs as a second partial selection signal Vf1. In other words, the inverter 53 outputs a low-level voltage signal if the inversion control signal Vs is at a high-level voltage and outputs a high-level voltage signal if the inversion control signal Vs is at a low-level voltage. The XOR circuits 52-1, 52-2, . . . , and 52-7 receive any one of the second control signals Vb1, Vb2, and Vb3 and an output signal from the inverter 53 or an output signal from another XOR circuit 52. The inversion control signal Vs and the second control signals Vb1, Vb2, and Vb3 are output signals from the counter circuit 17 illustrated in FIG. 15. The XOR circuits 52-1, 52-2, . . . , and 52-7 output the value of Xor of the received signals as second partial selection signals Vf2, Vf3, . . . , and Vf8, respectively. The inverter 53 is not necessarily provided, and the second code generation circuit 13 may output the inversion control signal Vs as the second partial selection signal Vf1.

The second code generation circuit 13 generates the second partial selection signals Vf corresponding to the second control signals Vb1, Vb2, and Vb3 and the inversion control signal Vs according to the truth table illustrated in FIG. 20. In FIG. 20, “1” is allocated if the signals are at a high-level voltage, and “0” is allocated if the signals are at a low-level voltage. The second code generation circuit 13 thus outputs the second partial selection signals Vf1, Vf2, . . . , and Vf8 having the phases determined based on a predetermined code to the respective drive signal supply line partial blocks sBKL in each of periods tb1, tb2, . . . , and tb16. The predetermined code is defined by the square matrix in Expression (2), for example. If the inversion control signal Vs is turned off (“0”), the second code generation circuit 13 generates the second partial selection signals Vf1, Vf2, . . . , and Vf8 corresponding to the elements “1” in the square matrix. If the inversion control signal Vs is turned on (“1”), the second code generation circuit 13 generates the second partial selection signals Vf1, Vf2, . . . , and Vf8 corresponding to the elements “−1” in the square matrix. The order of the square matrix is eight, which is equal to the number of second output terminals Yb.

The second code generation circuit 13 outputs the second partial selection signals Vf1, Vf2, . . . , and Vf8 from the respective second output terminals Yb in each of the periods tb1, tb2, . . . , and tb16. The combination patterns of turning-on and -off of the second partial selection signals Vf1, Vf2, . . . , and Vf8 are different from one another between the periods tb1, tb2, and tb16.

The combination patterns described above include combination patterns obtained by inverting turning-on and -off of the second partial selection signals Vf1, Vf2, . . . , and Vf8 because the second code generation circuit 13 receives the inversion control signal Vs. Specifically, the inversion control signal Vs is turned off in the periods tb1, tb3, tb5, tb7, tb9, tb11, tb13, and tb15 and turned on in the periods tb2, tb4, tb6, tb8, tb10, tb12, tb14, and tb16. The periods Tb1 and tb2, for example, have combination patterns of turning-on and -off of the second selection signals Vf1, Vf2, . . . , and Vf8 opposite to each other. Similarly, each pair of periods from the period tb3 to the period tb16 also has combination patterns opposite to each other. The number of combination patterns of turning-on and -off of the second partial selection signals Vf1, Vf2, . . . , and Vf8 is 16, which is twice the number of second output terminals Yb.

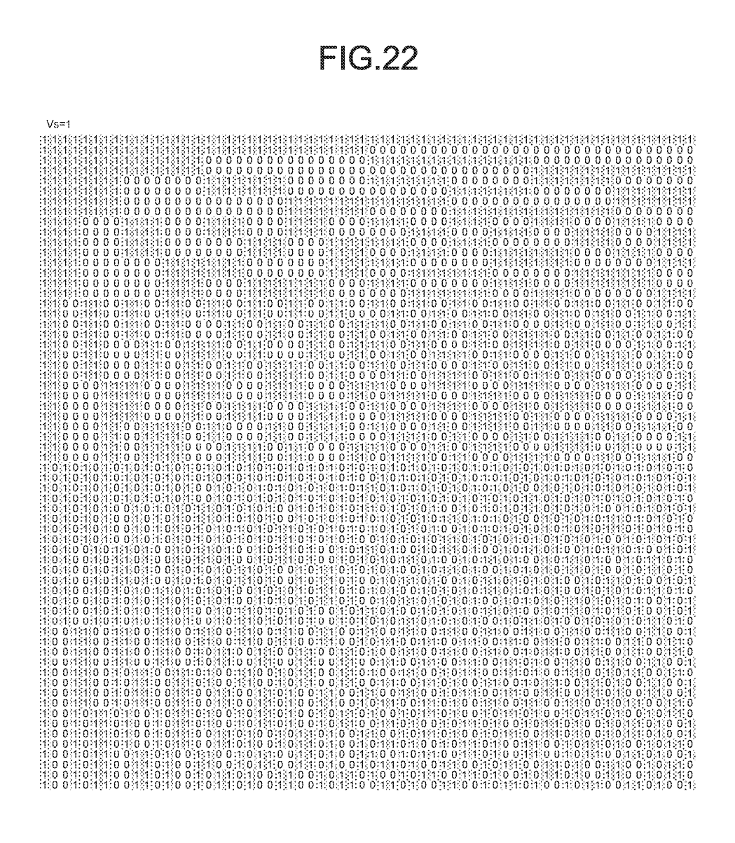

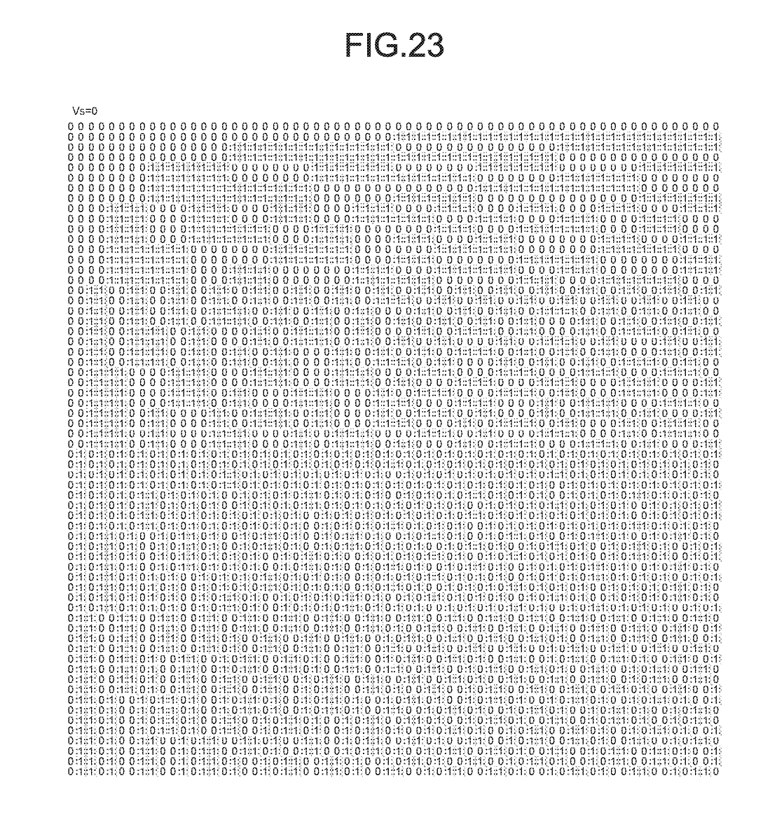

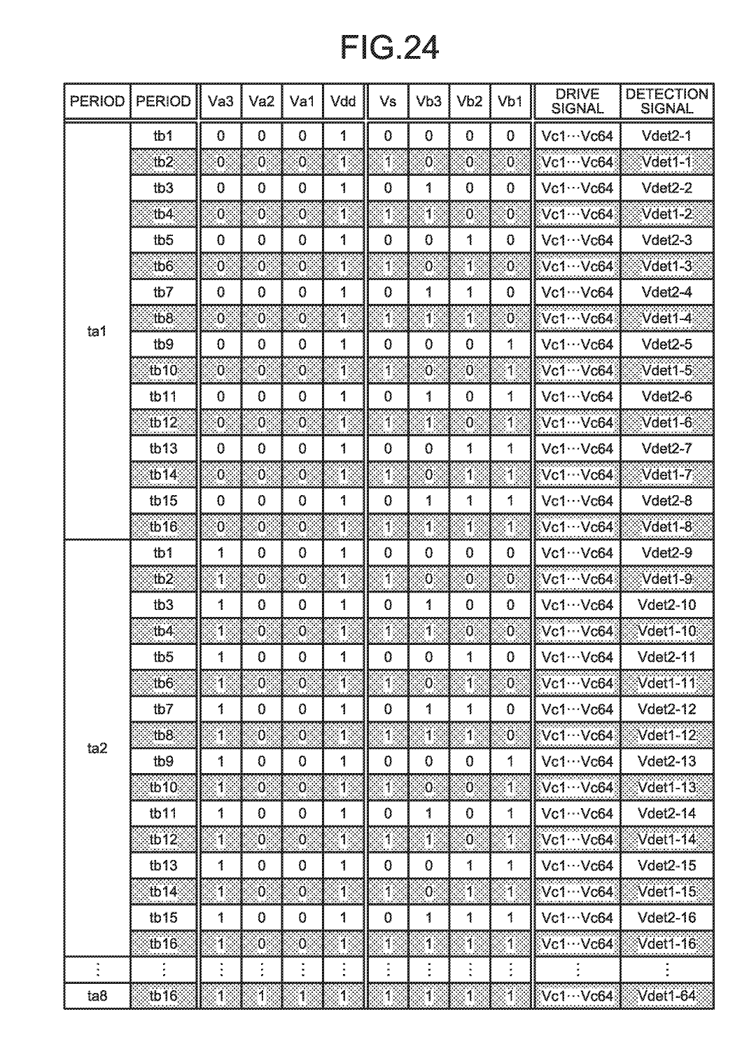

FIG. 21 is a circuit diagram of an example of the third code generation circuit. FIG. 22 illustrates an example of a pattern code generated by the third code generation circuit if the inversion control signal is at a high-level voltage. FIG. 23 illustrates an example of a pattern code generated by the third code generation circuit if the inversion control signal is at a low-level voltage. FIG. 24 is a table indicating the relation between the first control signals, the second control signals and the inversion control signal, and the detection signals.

FIG. 21 illustrates the third code generation circuit 14-1 provided to the drive signal supply line partial block sBKL1 out of the drive signal supply line partial blocks sBKL. As illustrated in FIG. 21, the third code generation circuit 14-1 includes a plurality of XOR circuits 54-1, 54-2, . . . , and 54-8. The XOR circuits 54-1, 54-2, . . . , and 54-8 receive the first partial selection signals Vd1, Vd2, . . . , and Vd8, respectively, from the first output terminals Ya of the first code generation circuit 12. The XOR circuits 54-1, 54-2, . . . , and 54-8 also receive the second partial selection signal Vf1 from the second output terminal Yb 1 of the second code generation circuit 13. The XOR circuits 54-1, 54-2, . . . , and 54-8 calculate Xor of the first partial selection signals Vd1, Vd2, . . . , and Vd8, respectively, and the second partial selection signal Vf1. The values calculated by the XOR circuits 54-1, 54-2, . . . , and 54-8 are supplied to the first electrodes Tx-1, Tx-2, . . . , and Tx-8 via the drive signal supply lines Ld1, Ld2, . . . , and Ld8, respectively, as the first selection signals Vc.

As illustrated in FIG. 15, the third code generation circuits 14-2, 14-3, . . . , and 14-8 receive the second partial selection signals Vf2, Vf3, . . . , and Vf8 (refer to FIG. 19) from the second output terminals Yb2, Yb3, . . . , and Yb8, respectively, of the second code generation circuit 13. The third code generation circuits 14-2, 14-3, . . . , and 14-8 also calculate Xor of the first partial selection signals Vd1, Vd2, . . . , and Vd8 and the received second partial selection signals Vf2, Vf3, . . . , and Vf8, respectively.

As illustrated in FIG. 18, the number of combination patterns of the first partial selection signals Vd is eight. As illustrated in FIG. 20, the number of combination patterns of the second partial selection signals Vf is eight in both of the cases where the inversion control signal Vs is 0 and 1, that is, 16 in total. Consequently, as illustrated in FIG. 22, the order of the pattern code (predetermined code) of the first partial selection signal Vd generated by the third code generation circuit 14 is 8×8=64 if the inversion control signal Vs is 1. Similarly, as illustrated in FIG. 23, the order of the pattern code of the first partial selection signal Vd generated by the third code generation circuit 14 is 8×8=64 if the inversion control signal Vs is 0. The pattern code illustrated in FIG. 23 is obtained by inverting “0” and “1” in the pattern code illustrated in FIG. 22.

The first code generation circuit 12, the second code generation circuit 13, and the third code generation circuit 14 provide first selection signals Vc1, . . . , and Vc64 corresponding to the pattern codes illustrated in FIGS. 22 and 23 according to the truth table illustrated in FIG. 24. The first selection signals Vc1, . . . , and Vc64 are substantially simultaneously supplied to the first electrodes Tx-1 to Tx-64, respectively. As illustrated in FIG. 24, if the inversion control signal Vs is 1, the second electrodes Rx output the first detection signals Vdet1. If the inversion control signal Vs is 0, the second electrodes Rx output the second detection signals Vdet2. The number of first detection signals Vdet1 and the number of second detection signals Vdet2 are 64 each, which corresponds to the order of the respective pattern codes.

The signal processor 44 (refer to FIG. 3) calculates the differences between the first detection signals Vdet1 and the second detection signals Vdet2. As a result, 64 third detection signals Vdet3 are calculated. The signal processor 44 decodes the third detection signals Vdet3 based on the predetermined code corresponding to the pattern codes illustrated in FIGS. 22 and 23. Based on the decoded signals Vdet4 calculated by the signal processor 44, the detection apparatus 1 can detect contact or proximity of the external proximity object CQ or an uneven shape on the surface of the external proximity object CQ facing the detection surface.

As illustrated in FIG. 24, the detection apparatus 1 alternately performs the processing in the periods when the inversion control signal Vs is 1 and the processing in the periods when the inversion control signal Vs is 0. As a result, the interval between the detection times for the first detection signal Vdet1 and the second detection signal Vdet2 is shortened. If noise components enter from the outside, calculating the difference between the first detection signal Vdet1 and the second detection signal Vdet2 can cancel the noise components. Consequently, the detection apparatus 1 can increase the detection accuracy.

The order of combinations of the first partial selection signals Vd and the second partial selection signals Vf is not limited to that illustrated in FIG. 24. For example, the detection apparatus 1 may successively perform the processing in a plurality of periods when the inversion control signal Vs is 1 and then successively perform the processing in a plurality of periods when the inversion control signal Vs is 0.

As described above, the detection apparatus 1 according to the present embodiment includes the first code generation circuit 12 and the second code generation circuit 13 (refer to FIG. 15). Based on the first partial selection signals Vd output from the first code generation circuit 12 and the second partial selection signals Vf output from the second code generation circuit 13, the first selection circuit 151 provides the first selection signals Vc having the phases determined based on the predetermined code for the respective first electrodes Tx. The detection apparatus 1 thus performs CDM drive on one first electrode block BK. The present embodiment can suppress delay of the signals and increase the detection accuracy compared with a case where shift registers supply the first selection signals Vc to all the first electrodes Tx, for example.

In the configuration according to the present embodiment, the counter circuit 17 provided on the sensor substrate 21 includes two external control terminals that receive the first clock signal FPS_CLK and the first reset signal FPS_RST. In other words, the configuration requires a smaller number of wires that couple the detection controller 11 and the counter circuit 17 on the sensor substrate 21. The number of output terminals of the counter circuit 17 is equal to the sum of the number of first input terminals A1, A2, and A3 of the first code generation circuit 12 and the number of second input terminals B1, B2, B3, and S of the second code generation circuit 13. The counter circuit 17 can have a simpler configuration because the detection apparatus 1 includes the first code generation circuit 12, the second code generation circuit 13, and the third code generation circuit 14. Specifically, the pattern codes with 64 order illustrated in FIGS. 22 and 23, for example, are generated based on the output signals from the flip-flop circuits 18 of seven stages in both of the cases where the inversion control signal Vs is turned on and off. With this configuration, the detection apparatus 1 can suppress delay of the signals in the counter circuit 17 and supply the first selection signals Vc corresponding to a large number of first electrodes Tx substantially simultaneously to the third selection circuit 153.

The third code generation circuit 14 according to the present embodiment may calculate the negation of exclusive or (Xnor) of the first partial election signals Vd and the second partial selection signal Vf1. Alternatively, the third code generation circuit 14 may perform substantially the same arithmetic operation as the logical operation for Xor or Xnor. The configurations of the first code generation circuit 12 and the second code generation circuit 13 may be appropriately modified.

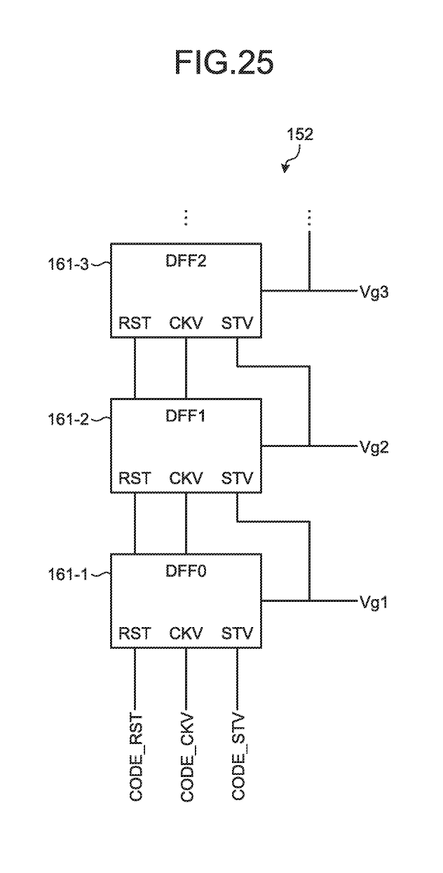

The following describes the second selection circuit 152. FIG. 25 is a block diagram of the second selection circuit of the first electrode selection circuit. As illustrated in FIG. 25, the second selection circuit 152 is a shift register including a plurality of transmission circuits and includes a plurality of flip-flop circuits 161-1, 161-2, 161-3, . . . as the transmission circuits, for example. The second selection circuit 152 operates based on a code control signal CODE_STV, a code clock signal CODE_CKV, and a code reset signal CODE_RST.

The flip-flop circuits 161-1, 161-2, and 161-3 are logic circuits that sequentially transmit the code control signal CODE_STV to the next flip-flop circuits 161-1, 161-2, and 161-3 based on the code clock signal CODE_CKV. The flip-flop circuits 161-1, 161-2, and 161-3 provide second selection signals Vg1, Vg2, and Vg3, respectively, based on the code control signal CODE_STV and sequentially output the second selection signals Vg1, Vg2, and Vg3 to respective latches 162 (refer to FIG. 14). The latch 162 is a circuit that temporarily stores therein the second selection signal Vg. If the code control signal CODE_STV is transmitted to all the flip-flop circuits 161-1, 161-2, and 161-3, the flip-flop circuits 161-1, 161-2, and 161-3 are reset by the code reset signal CODE_RST.

As illustrated in FIG. 14, the flip-flop circuits 161 and the latches 162 included in the second selection circuit 152 are provided for the respective first electrode blocks BK. The code control signal CODE_STV is generated by an external component, such as the detection controller 11 (refer to FIG. 3). The code control signals CODE_STV have the phases determined based on a predetermined code for the respective first electrode blocks BK. In other words, the second selection signals Vg1, Vg2, and Vg3 are control signals having the phases determined based on the predetermined code for the respective first electrode blocks BK.

If the second selection signals Vg are supplied to all the latches 162, the latches 162 supply the second selection signals Vg substantially simultaneously to the third selection circuit 153 based on an enable signal OUT_ENB.

As illustrated in FIG. 14, the third selection circuit 153 includes a plurality of XOR circuits 164 and a plurality of negative AND (NAND) circuits 165. The XOR circuits 164 and the NAND circuits 165 are provided for the respective first electrodes Tx. The third code generation circuits 14 of the first selection circuit 151 are disposed such that they supply the signals having different phases determined based on the predetermined code to the first electrodes Tx included in the respective first electrode blocks BK. In two first electrode blocks BK disposed side by side, the same signal is supplied to the first electrode blocks BK provided at the same position in the direction in which the first electrode blocks BK are disposed side by side. By contrast, common signals are output from the second selection circuit 152 and the first electrode block selection circuit 154 to the XOR circuits 164 and the NAND circuits 165 included in one first electrode block BK. The third code generation circuits 14 output the first selection signals Vc corresponding to the pattern codes illustrated in FIGS. 22 and 23 to the XOR circuits 164. The second selection circuit 152 outputs the second selection signals Vg to the XOR circuits 164. The XOR circuits 164 output the value of Xor of the first selection signal Vc and the second selection signal Vg to the respective NAND circuits 165 as the third selection signal Vk.

In the second detection mode M2 (refer to FIG. 9) or the third detection mode M3 (refer to FIG. 10), the third code generation circuit 14 provides the first selection signals Vc having the phases based on the predetermined code for the respective first electrodes Tx. The third code generation circuits 14 provide the first selection signals Vc corresponding to the same pattern code for the respective first electrode blocks BK.

The second selection signals Vg have the phases determined based on the predetermined code for the respective first electrode blocks BK. The XOR circuits 164 calculate Xor of the first selection signal Vc and the second selection signal Vg, thereby providing different third selection signals Vk for the respective first electrode blocks BK. The third selection signal Vk is a signal for selecting the first electrodes Tx included in a plurality of first electrode blocks BK. The third selection circuit 153 supplies the second drive signals Vtx2 having the phases determined based on the third selection signals Vk to a plurality of first electrodes Tx. The detection apparatus 1 thus can perform CDM drive on the whole detection region FA.

As illustrated in FIG. 14, the first electrode block selection circuit 154 is a shift register including a plurality of transmission circuits and includes a plurality of flip-flop circuits 163 as the transmission circuits, for example. The flip-flop circuits 163 are logic circuits provided for the respective first electrode blocks BK. The first electrode block selection circuit 154 operates based on a mask control signal MASK_STV, a mask clock signal MASK_CKV, and a mask reset signal MASK_RST. If the mask control signal MASK_STV is turned on (high-level voltage), the flip-flop circuit 163 outputs the first electrode block selection signal Vh at a high-level voltage to the third selection circuit 153. As a result, the corresponding first electrode block BK is selected as a target to be driven. If the mask control signal MASK_STV is turned off (low-level voltage), the flip-flop circuit 163 outputs the first electrode block selection signal Vh at a low-level voltage to the third selection circuit 153. As a result, the corresponding first electrode block BK is not selected.

The NAND circuit 165 of the third selection circuit 153 receives the first electrode block selection signal Vh and calculates negative and (nand) of the third selection signal Vk and the first electrode block selection signal Vh. In other words, if the first electrode block selection signal Vh is at a high-level voltage, the NAND circuit 165 generates a high-level voltage signal. The NAND circuit 165 outputs the high-level voltage signal to the buffer 166 as the first drive signal Vtx1 or the second drive signal Vtx2. If the first electrode block selection signal Vh is at a low-level voltage, the NAND circuit 165 generates a low-level voltage signal. The NAND circuit 165 outputs the low-level voltage signal to the buffer 166 as the first drive signal Vtx1 or the second drive signal Vtx2. The buffer 166 supplies the first drive signals Vtx1 or the second drive signals Vtx2 substantially simultaneously to a plurality of selected first electrode blocks BK.

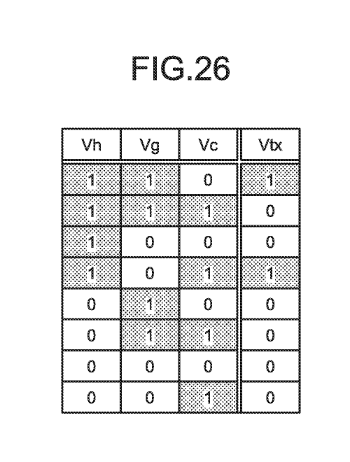

By performing the operations described above, the third selection circuit 153 generates the drive signals Vtx (the first drive signals Vtx1 or the second drive signals Vtx2) based on Expression (3). FIG. 26 is a table indicating the relation between the first selection signal, the second selection signal, the first electrode block selection signal, and the drive signal. The first electrode selection circuit 15 generates the drive signals Vtx (the first drive signals Vtx1 or the second drive signals Vtx2) corresponding to the first selection signals Vc, the second selection signals Vg, and the first electrode block selection signals Vh according to the truth table illustrated in FIG. 26.

Vtx=(Vc XOR Vg)NAND Vh (3)

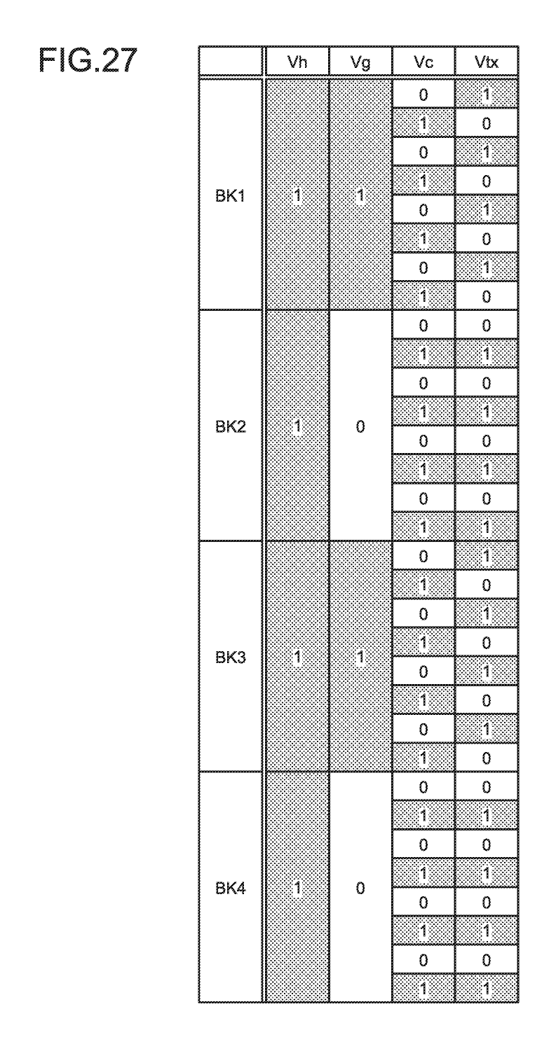

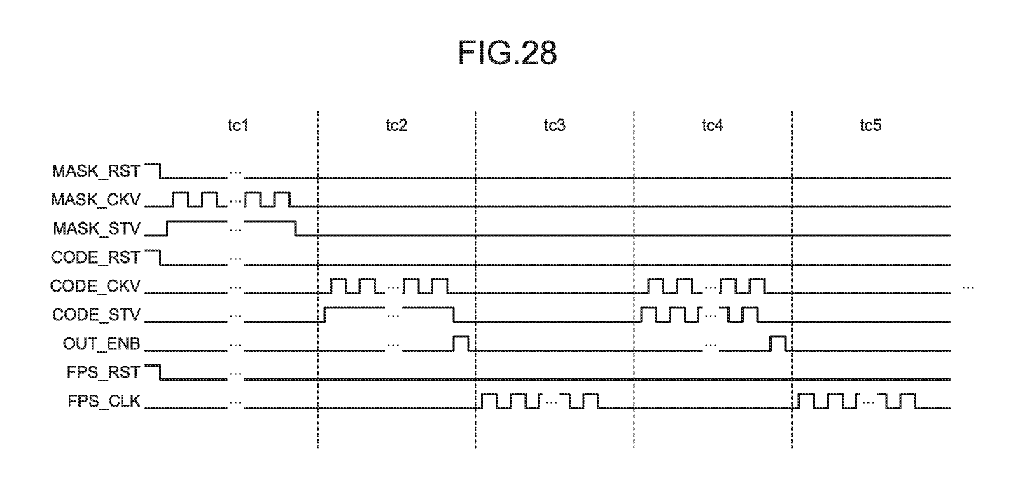

The following describes exemplary operations performed by the first electrode selection circuit 15 in the respective detection modes. FIG. 27 is a table indicating the relation between the first electrode blocks and the selection signals in the second detection mode. FIG. 28 is a timing waveform chart of the first electrode selection circuit in the second detection mode. To simplify the explanation, FIG. 27 illustrates four first electrode blocks BK1, BK2, BK3, and BK4. In FIG. 27, the first electrode blocks BK each include eight first electrodes Tx.

In the second detection mode M2 (refer to FIG. 9), the detection apparatus 1 performs fingerprint detection on the whole surface of the detection region FA. As illustrated in FIG. 27, the first electrode block selection circuit 154 supplies the first electrode block selection signals Vh at a high-level voltage to the third selection circuit 153 based on the mask control signal MASK_STV. The first electrode block selection signals Vh corresponding to all the first electrode blocks BK are turned on (“1”). As a result, all the first electrode blocks BK are selected. The first selection circuit 151 and the second selection circuit 152 provide the first selection signals Vc and the second selection signals Vg, respectively, having the phases determined based on the predetermined code and supply the generated signals to the third selection circuit 153. The third selection circuit 153 multiplies the first selection signals Vc by the second selection signals Vg, thereby generating the second drive signals Vtx2 having the phases determined based on the predetermined code for the respective first electrodes Tx. The third selection circuit 153 supplies the second drive signals Vtx2 to the respective first electrodes Tx. The detection apparatus 1 thus can perform CDM drive on the whole surface of the detection region FA.

As illustrated in FIG. 28, in a first period tc1, the first electrode block selection circuit 154 starts to operate using the mask reset signal MASK_RST as a trigger. The mask control signal MASK_STV at a high-level voltage is transmitted to all the flip-flop circuits 163 based on the mask clock signal MASK_CKV. The first electrode block selection circuit 154 generates the first electrode block selection signals Vh and turns on (“1”) the first electrode block selection signals Vh corresponding to all the first electrode blocks BK. As a result, all the first electrode blocks BK are selected.

In a second period tc2, the code control signal CODE_STV is supplied to the flip-flop circuits 161 in the second selection circuit 152 based on the code clock signal CODE_CKV. The second selection circuit 152 provides the second selection signals Vg having the phases determined based on the predetermined code for the respective first electrode blocks BK based on the code control signal CODE_STV. The second selection signals Vg output from the respective flip-flop circuits 161 are held in the respective latches 162. If all the data of the code control signal CODE_STV is transmitted, the latches 162 output the second selection signals Vg to the third selection circuit 153 based on the enable signal OUT_ENB.

In a third period tc3, the first selection circuit 151 provides the first selection signals Vc having the phases determined based on the predetermined code for the respective first electrodes Tx based on the first reset signal FPS_RST and the first clock signal FPS_CLK. In the third period tc3, different combinations of the first selection signals Vc are supplied to the third selection circuit 153 corresponding to the number of pattern codes. In the example illustrated in FIG. 27, for example, the number of pattern codes is eight. In other words, the first selection circuit 151 provides different combinations of the first selection signals Vc eight times in the third period tc3. Combinations of the second drive signals Vtx2 corresponding to the respective combinations of the first selection signals Vc are supplied to the respective first electrode blocks BK to perform detection eight times.

In a fourth period tc4, the second selection circuit 152 provides the second selection signals Vg having the phases determined based on the predetermined code based on the code control signal CODE_STV different from that in the second period tc2. The processing in a fifth period tc5 is the same as that in the third period tc3. By repeating the operations described above, the detection apparatus 1 performs detection using all the combinations of the first selection signals Vc generated by the first selection circuit 151 and the second selection signals Vg generated by the second selection circuit 152. Let us assume a case where the number of combinations of the first selection signals Vc corresponding to the predetermined code (first code) is eight, for example. If the number of first electrode blocks BK is four, the number of combinations of the second selection signals Vg corresponding to the predetermined code (second code) is four. In this case, the number of second drive signals Vtx2 corresponding to all the combinations is 32 (=4×8). Consequently, the number of periods for supplying all the second drive signals Vtx2 is 32 in total. The detection apparatus 1 thus can perform CDM drive in the second detection mode M2. In this case, the detection apparatus 1 obtains the decoded signals Vdet4 from the third detection signals Vdet3 based on the first code and the second code. Specifically, the detection apparatus 1 obtains the decoded signals by performing inversion operations stepwise on a first Hadamard matrix corresponding to the first code and a second Hadamard matrix corresponding to the second code.

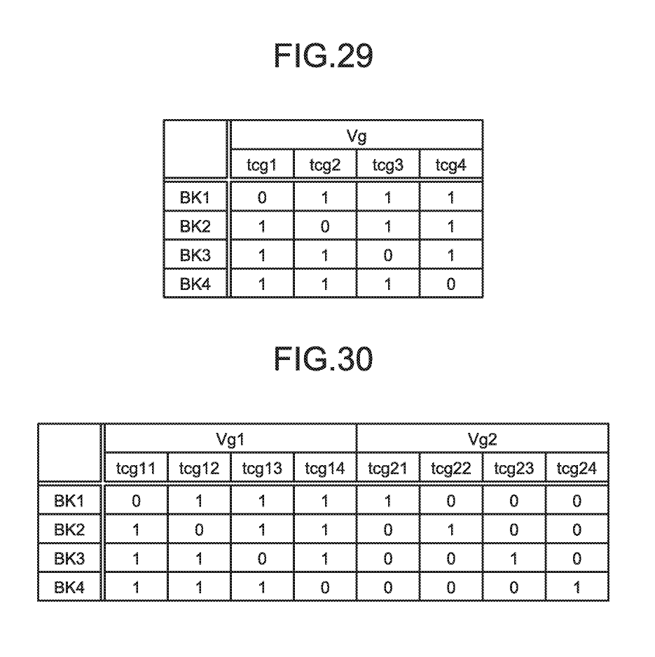

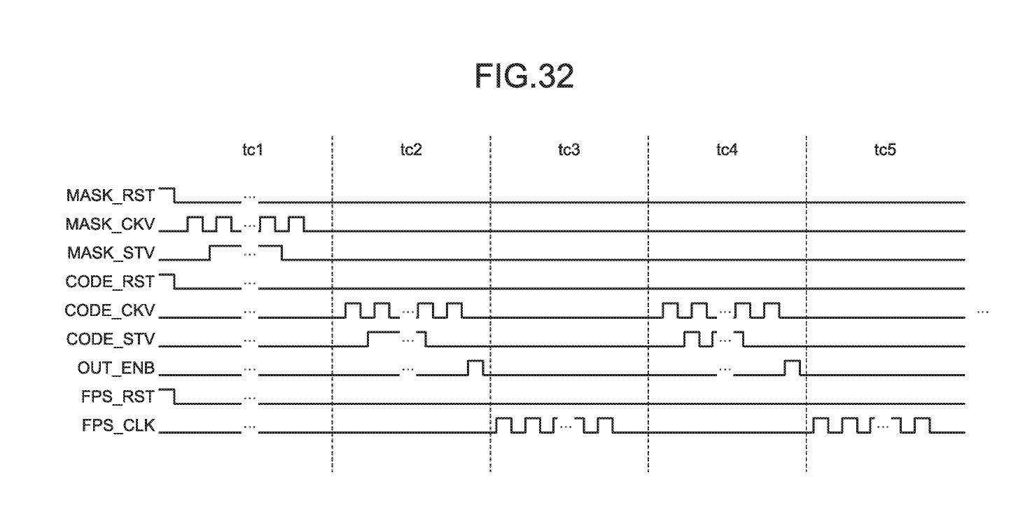

More specifically, the following describes a case where the second selection circuit 152 outputs the second selection signals Vg based on the predetermined code (second code) if the predetermined code (second code) is the Hadamard matrix represented by Expression 1. FIG. 29 is a table indicating the second selection signals for the respective first electrode blocks in each holding period. As illustrated in FIG. 29, in a first holding period Vcg1, the second selection signal Vg for the first electrode block BK1 is turned off (“0”), and the second selection signals Vg for the first electrode blocks BK2, BK3, and BK4 are turned on (“1”). In a second holding period Vcg2, the second selection signal Vg for the first electrode block BK2 is turned off (“0”), and the second selection signals Vg for the first electrode blocks BK1, BK3, and BK4 are turned on (“1”). In a third holding period Vcg3, the second selection signal Vg for the first electrode block BK3 is turned off (“0”), and the second selection signals Vg for the first electrode blocks BK1, BK2, and BK4 are turned on (“1”). In a fourth holding period Vcg4, the second selection signal Vg for the first electrode block BK4 is turned off (“0”), and the second selection signals Vg for the first electrode blocks BK1, BK2, and BK3 are turned on (“1”). The first holding period Vcg1 to the fourth holding period Vcg4 correspond to the second period tc2 and the fourth period tc4 illustrated in FIG. 28 and FIG. 32, which will be described later.

The second selection circuit 152 may perform inversion control. FIG. 30 is a table indicating another example of the second selection signals for the respective first electrode blocks in each holding period. As illustrated in FIG. 30, the second selection circuit 152 may output second selection signals Vg1 based on the predetermined code and second selection signals Vg2 obtained by inverting the second selection signals Vg1.

More specifically, as illustrated in FIG. 30, the second selection circuit 152 may output signals corresponding to the second selection signals Vg1 from a second holding period Vcg11 to a second holding period Vcg14 and output signals corresponding to the second selection signals Vg2 from a second holding period Vcg21 to a second holding period Vcg24. While the second selection circuit 152 finishes outputting all the combination patterns included in the second selection signals Vg1 and then outputs the combination patterns included in the second selection signals Vg2 in FIG. 30, the present embodiment is not limited thereto. The second selection circuit 152 may output one combination pattern included in the second selection signals Vg1 and then output the second selection signals Vg2 obtained by inverting the combination pattern.

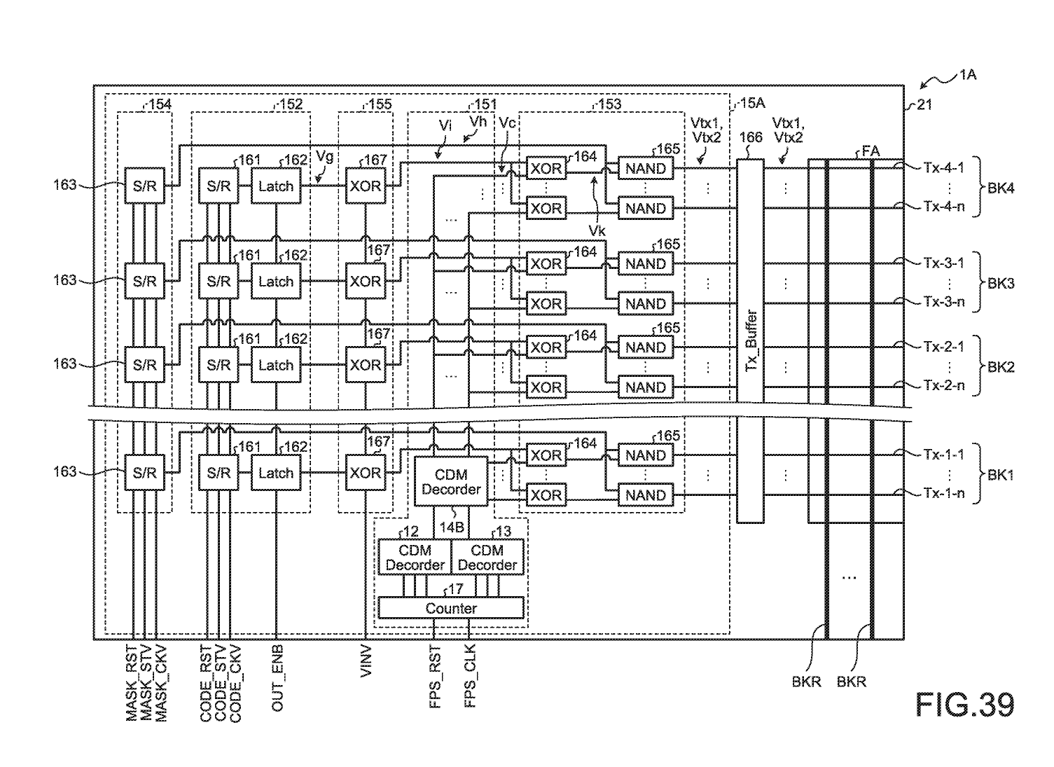

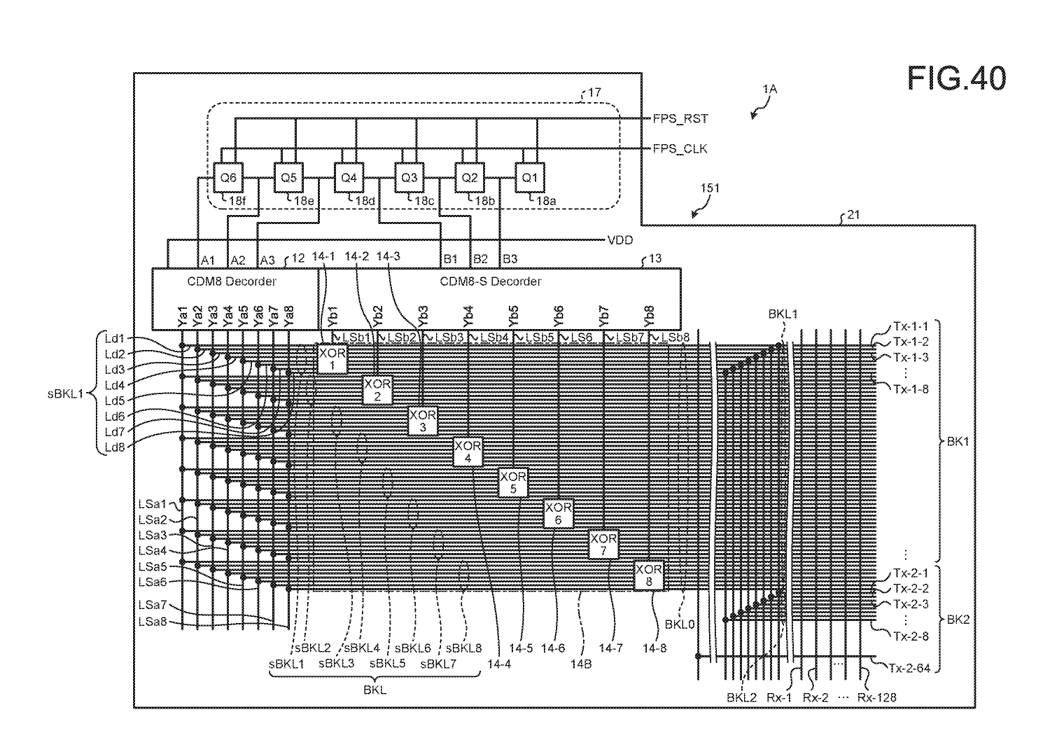

If the second selection circuit 152 performs inversion control as described above, the first selection circuit 151 and the second selection circuit 152 do not require any inversion control circuit, which will be described later. Specifically, the detection apparatus 1 does neither require any circuit that generates and outputs the inversion control signal Vs as illustrated in FIG. 40, which will be described later, nor an inversion control circuit 155 illustrated in FIG. 39.

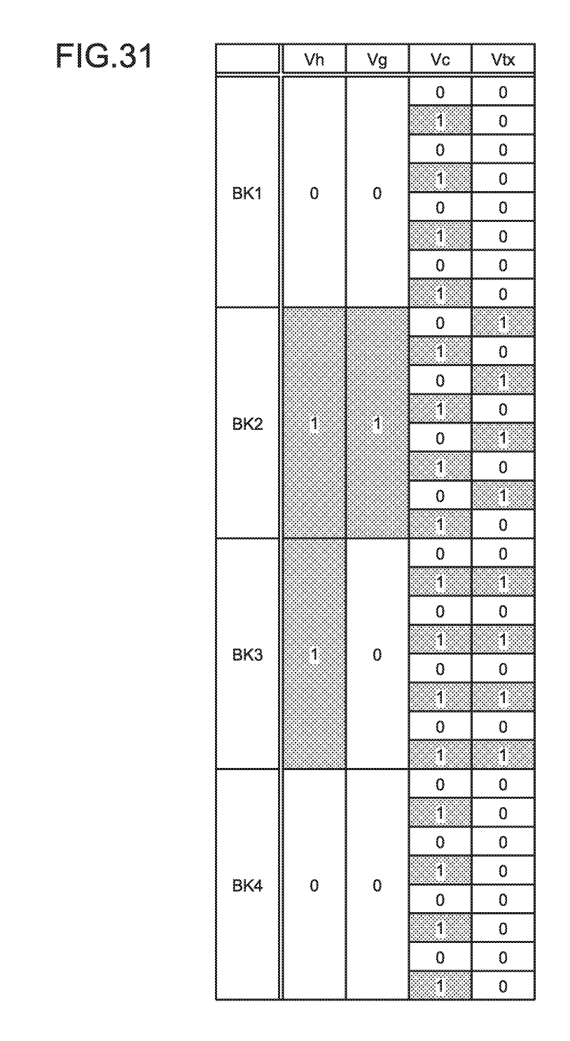

FIG. 31 is a table indicating the relation between the first electrode blocks and the selection signals in the third detection mode. FIG. 32 is a timing waveform chart of the first electrode selection circuit in the third detection mode.

In the third detection mode M3 (refer to FIG. 10), the detection apparatus 1 performs fingerprint detection on the first partial region FA1, which is part of the detection region FA. As illustrated in FIG. 31, the first electrode block selection circuit 154 turns on (“1”) the first electrode block selection signals Vh corresponding to the first electrode blocks BK2 and BK3 out of all the first electrode blocks BK based on the mask control signal MASK_STV. The first electrode block selection circuit 154 turns off (“0”) the first electrode block selection signals Vh corresponding to the first electrode blocks BK1 and BK4. As a result, part of the first electrode blocks BK, that is, the first electrode blocks BK2 and BK3 are selected.

The second selection circuit 152 provides the second selection signals Vg corresponding to the selected first electrode blocks BK2 and BK3. The first selection circuit 151 generates the first selection signals Vc in the same manner as illustrated in FIG. 27. The third selection circuit 153 multiplies the first selection signals Vc by the second selection signals Vg, thereby generating the second drive signals Vtx2. The third selection circuit 153 supplies the second drive signals Vtx2 to the first electrode blocks BK2 and BK3 selected by the first electrode block selection circuit 154. The detection apparatus 1 thus can perform CDM drive on the first partial region FA1, which is part of the detection region FA.

As illustrated in FIG. 32, in the first period tc1, the mask control signal MASK_STV at a high-level voltage is transmitted to the flip-flop circuits 163 corresponding to the first electrode blocks BK2 and BK3 in the first electrode block selection circuit 154 based on the mask clock signal MASK_CKV. As a result, the first electrode blocks BK2 and BK3 out of all the first electrode blocks BK are selected.

In the second period tc2 and the fourth period tc4, the code control signal CODE_STV is supplied to the flip-flop circuits 161 corresponding to the first electrode blocks BK2 and BK3 in the second selection circuit 152. The detection apparatus 1 thus performs CDM drive on the first electrode blocks BK2 and BK3 selected from all the first electrode blocks BK. The operations performed by the first selection circuit 151 in the third period tc3 and the fifth period tc5 are the same as those illustrated in FIG. 28.

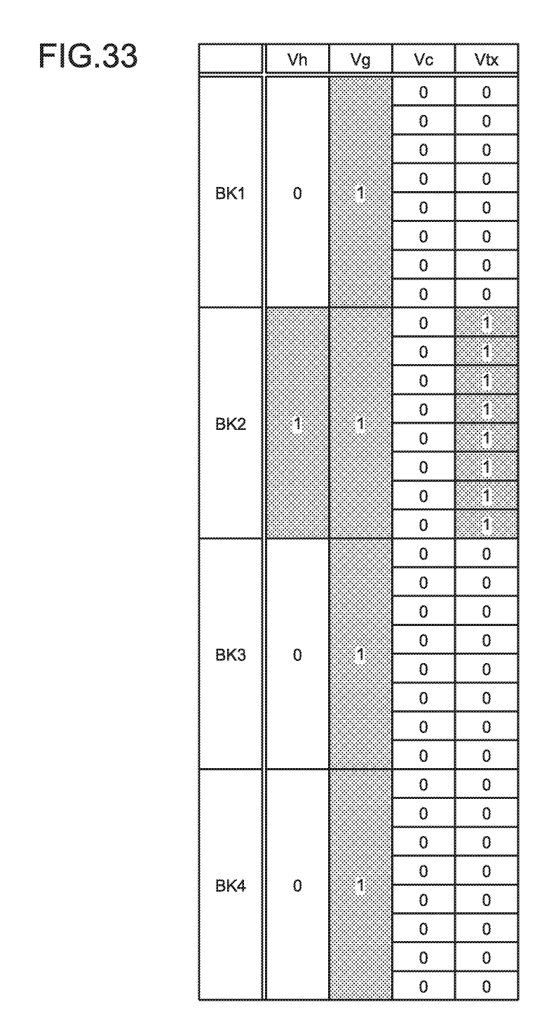

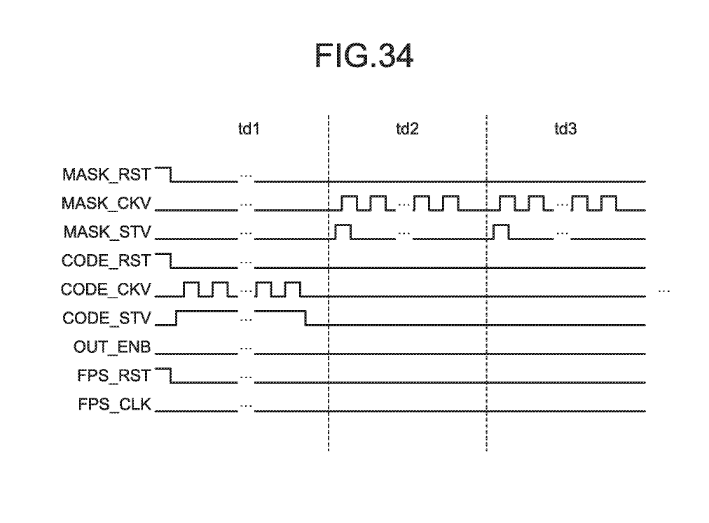

FIG. 33 is a table indicating the relation between the first electrode blocks and the selection signals in TDM drive in the first detection mode. FIG. 34 is a timing waveform chart of the first electrode selection circuit in TDM drive in the first detection mode.

As illustrated in FIG. 33, in TDM drive in the first detection mode M1 (refer to FIG. 8), the first selection circuit 151 turns off (“0”) all the first selection signals Vc. The second selection circuit 152 turns on (“1”) all the second selection signals Vg. As a result, CDM drive is not performed. The first electrode block selection circuit 154 turns on (“1”) the first electrode block selection signal Vh corresponding to the first electrode block BK2 out of the first electrode blocks BK. As a result, the first drive signal Vtx1 is supplied to the first electrode block BK2. The first electrode block selection circuit 154 sequentially selects the first electrode blocks BK1, BK2, BK3, and BK4. As a result, the third selection circuit 153 supplies the first drive signals Vtx1 to the respective selected first electrode blocks BK in a time-division manner. In FIG. 33, the same first drive signal Vtx1 is supplied to all the first electrodes Tx in the selected first electrode block BK2. The detection apparatus 1 thus can perform touch detection by TDM drive.

As illustrated in FIG. 34, in a first period td1, the code control signal CODE_STV is supplied to the flip-flop circuits 161 in the second selection circuit 152 based on the code clock signal CODE_CKV. As a result, all the first electrode blocks BK are selected. In a second period td2, the mask control signal MASK_STV at a high-level voltage is sequentially supplied to the flip-flop circuits 163 in the first electrode block selection circuit 154 based on the mask clock signal MASK_CKV. As a result, the first electrode block BK1 is selected in the second period td2, for example. In and after a third period td3, the detection apparatus 1 performs the same operation as that performed in the second period td2, thereby sequentially scanning the first electrode blocks BK2, BK3, and BK4. The number of periods for supplying all the first drive signals Vtx1 in the first detection mode M1 is four, which is equal to the number of first electrode blocks BK.

As described above, the period in which the first electrode selection circuit 15 supplies all the second drive signals Vtx2 resulting from the predetermined code to the first electrodes Tx in the second detection mode M2 (refer to FIG. 28) is longer than the period in which the first electrode selection circuit 15 sequentially supplies the first drive signals Vtx1 to all the first electrode blocks BK in the first detection mode M1 (refer to FIG. 34). In the example illustrated in FIG. 28, the number of periods for supplying all the second drive signals Vtx2 in the second detection mode M2 is 32 in total. In the example illustrated in FIG. 34, the number of periods for supplying all the first drive signals Vtx1 in the first detection mode M1 is four.

In FIG. 33, the first electrode selection circuit 15 supplies the same first drive signal Vtx1 to all the first electrodes Tx in the selected first electrode block BK2. The present embodiment is not limited thereto, and the first electrode selection circuit 15 may supply the first drive signal Vtx1 to part of the first electrodes Tx in the selected first electrode block BK2. The first selection circuit 151, for example, may provide the first selection signals Vc corresponding to the first electrodes Tx supplied with no first drive signal Vtx1 in the first electrode block BK2, thereby performing thinned-out drive. Consequently, the detection apparatus 1 can reduce power consumption.

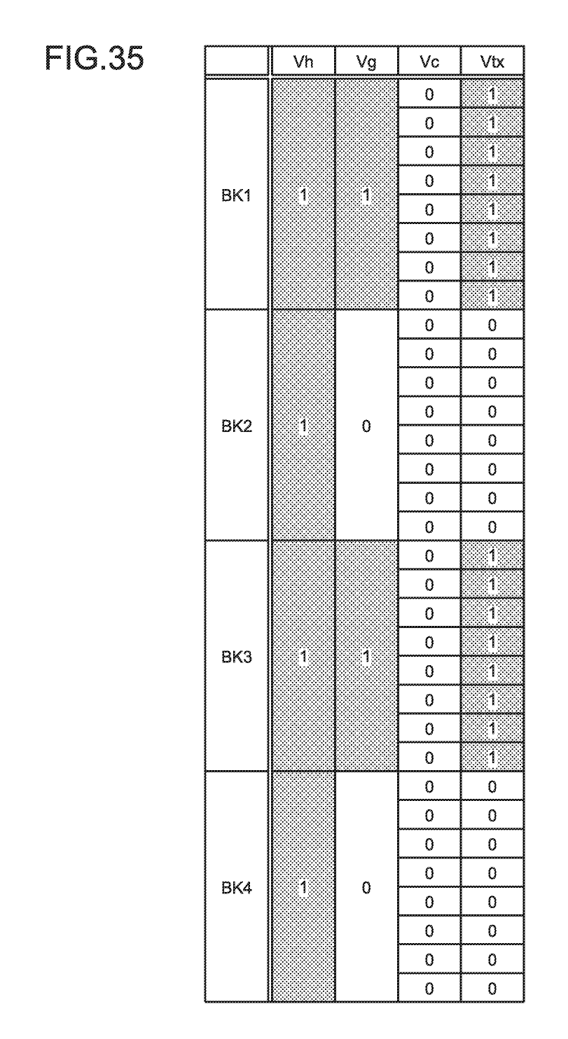

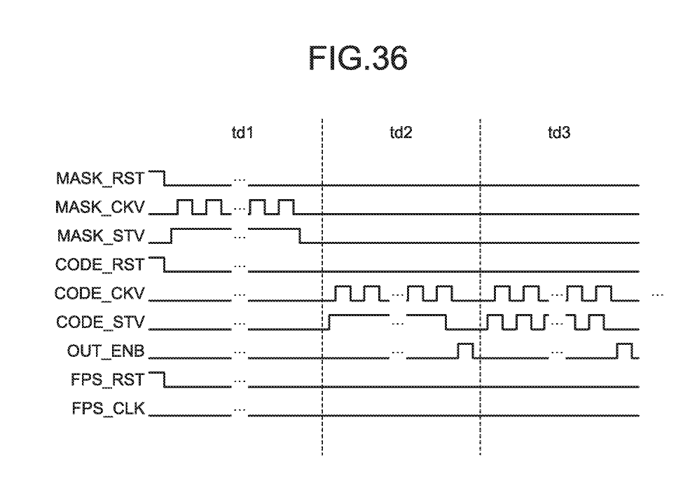

FIG. 35 is a table indicating the relation between the first electrode blocks and the selection signals in CDM drive in the first detection mode. FIG. 36 is a timing waveform chart of the first electrode selection circuit in CDM drive in the first detection mode.

As illustrated in FIG. 35, in CDM drive in the first detection mode M1 (refer to FIG. 8), the first electrode block selection circuit 154 supplies the first electrode block selection signals Vh at a high-level voltage to the third selection circuit 153. As a result, the first electrode block selection signals Vh corresponding to all the first electrode blocks BK are turned on (“1”), and all the first electrode blocks BK are selected. The first selection circuit 151 supplies the first selection signals Vc at a low-level voltage to the third selection circuit 153. As a result, all the first selection signals Vc are turned off (“0”), and CDM drive is not performed in units of the first electrode Tx.

The second selection circuit 152 supplies, to the third selection circuit 153, the second selection signals Vg having the phases determined based on the predetermined code for the respective first electrode blocks BK. As a result, the first drive signals Vtx1 are supplied to the first electrode blocks BK selected based on the predetermined code. The second selection circuit 152 outputs the second selection signals Vg with different combination patterns of the second selection signals Vg for the respective first electrode blocks BK. The detection apparatus 1 thus performs touch detection by CDM drive.

As illustrated in FIG. 36, in the first period td1, the mask control signal MASK_STV at a high-level voltage is supplied to the flip-flop circuits 163 in the first electrode block selection circuit 154 based on the mask clock signal MASK_CKV. As a result, all the first electrode blocks BK are selected. In the second period td2, the first drive signals Vtx1 are supplied to the respective first electrode blocks BK by the operations of the second selection circuit 152. In and after the third period td3, the first drive signals Vtx1 are supplied to another combination of the first electrode blocks BK different from that in the second period td2.

In the fourth detection mode M4, the detection apparatus 1 performs CDM drive in the same manner as that in the third detection mode M3 on a partial region including the first electrode blocks BK in which an external proximity object is detected in the first detection mode M1. More specifically, the first electrode block selection circuit 154 outputs the first electrode block selection signals Vh so as to select the partial region including the first electrode blocks BK in which the external proximity object is detected in the first detection mode M1. Explanation of the operations performed by the first selection circuit, the second selection circuit, and the third selection circuit is omitted because the operations are the same as those in the third detection mode M3.

As described above, the first electrode selection circuit 15 includes the first selection circuit 151, the second selection circuit 152, the third selection circuit 153, and the first electrode block selection circuit 154. With this configuration, the detection apparatus 1 can satisfactorily perform the first detection mode M1 and the second detection mode M2. Furthermore, the detection apparatus 1 can perform partial detection of performing detection on part of the detection region FA, for example, in the third detection mode M3 and the fourth detection mode M4. The first electrode block selection circuit 154 and the second selection circuit 152 have functions of selecting the first electrode blocks BK in the first detection mode M1. With this configuration, the detection apparatus 1 does not require another control circuit for touch detection or another switching circuit that switches between touch detection and fingerprint detection. As a result, the circuit size can be reduced. The first selection circuit 151 provides the first selection signals Vc based on the predetermined code. This configuration requires a smaller number of external terminals and wires used to supply the control signals from the outside to the first selection circuit 151.

While the first selection circuit 151 includes the counter circuit 17 as illustrated in FIGS. 14 and 15, the present embodiment is not limited thereto. The first selection circuit 151 does not necessarily include the counter circuit 17 and may include the first code generation circuit 12, the second code generation circuit 13, and the third code generation circuit 14. In this case, the external detection controller 11 (refer to FIG. 3) may supply the inversion control signal Vs, the first control signals Va1, Va2, and Va3, and the second control signals Vb1, Vb2, and Vb3 illustrated in FIG. 16 to the first code generation circuit 12 and the second code generation circuit 13.

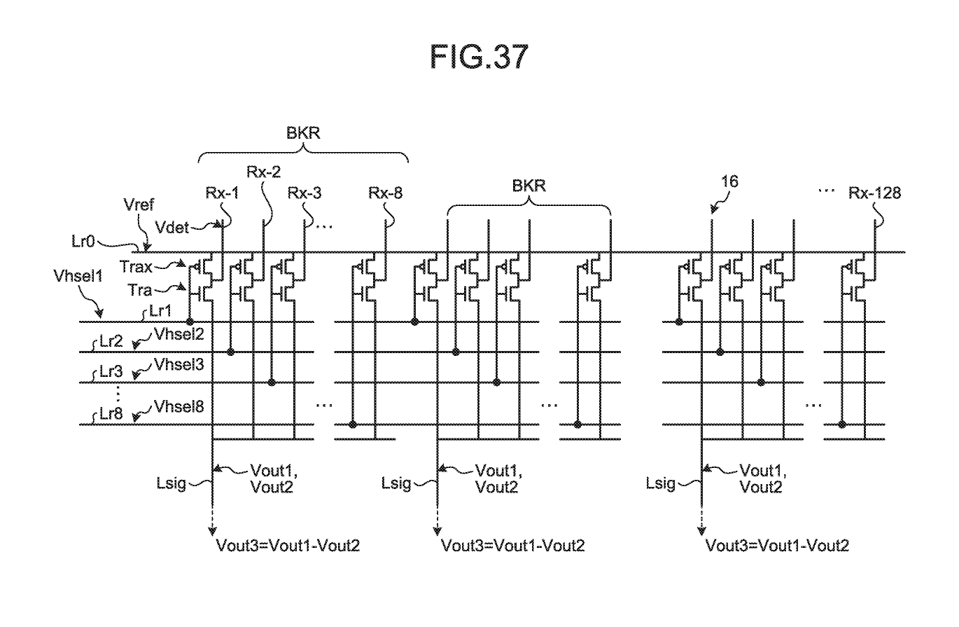

FIG. 37 is a circuit diagram of the detection electrode selection circuit according to the first embodiment. As illustrated in FIG. 37, detection electrode blocks BKR each include a plurality of second electrodes Rx-1, Rx-2, . . . , and Rx-8. In FIG. 37, 128 second electrodes Rx, that is, second electrodes Rx-1 to Rx-128 are provided. The detection electrode selection circuit 16 includes first switching elements Tra, second switching elements Trax, a reference potential supply line Lr0, second electrode selection signal lines Lr1, Lr2, . . . , and Lr8, and output signal lines Lsig. The detection electrode blocks BKR are each provided with one output signal line Lsig. The output signal lines Lsig are coupled to the detector 40 (refer to FIG. 3). The detection electrode selection circuit 16 selects the second electrodes Rx to be a target of detection based on the second electrode selection signals Vhsel.

The second electrodes Rx are each coupled to the first switching element Tra and the second switching element Trax. Second electrode selection signals Vhsel1, Vhsel2, Vhsel3, . . . , and Vhsel8 are supplied to the first switching elements Tra and the second switching elements Trax via the second electrode selection signal lines Lr1, Lr2, . . . , and Lr8, respectively. When the same second electrode selection signal Vhsel is supplied, the first switching element Tra and the second switching element Trax are turned on and off in an opposite manner. In other words, if the first switching element Tra is turned on, the second switching element Trax is turned off. If the first switching element Tra is turned off, the second switching element Trax is turned on. The second electrode selection signals Vhsel can be generated based on various control signals supplied from the detection controller 11, for example.

The first switching element Tra and the second switching element Trax operate to switch the coupling state of the corresponding second electrode Rx included in the detection electrode block BKR to the output signal line Lsig. If the first switching element Tra is turned on, the second electrode Rx is coupled to the output signal line Lsig. If the second switching element Trax is turned on, the second electrode Rx is coupled to the reference potential supply line Lr0.

The second electrode selection signal Vhsel is a selection signal resulting from a predetermined code. The predetermined code is defined by the square matrix in Expression (2), for example. The second electrode selection signal Vhsel is generated by a circuit similar to the first code generation circuit 12 (refer to FIG. 17) or the second code generation circuit 13 (refer to FIG. 19). If the second electrode selection signal Vhsel corresponding to the elements “1” in Expression (2) is supplied, the first switching element Tra is turned on. If the second electrode selection signal Vhsel corresponding to the elements “−1” in Expression (2) is supplied, the second switching element Trax is turned on. As a result, the second electrodes Rx are selected based on the predetermined code similarly to CDM drive illustrated in FIG. 13.

Specifically, if a plurality of second electrodes Rx corresponding to the elements “1” in Expression (2) are selected, the selected second electrodes Rx are coupled to the output signal line Lsig. A first output signal Vout1 obtained by integrating the first detection signals Vdet1 from the selected second electrodes Rx is output from the output signal line Lsig. Non-selected second electrodes Rx are coupled to the reference potential supply line Lr0 and supplied with a reference potential signal Vref. The reference potential signal Vref is a direct-current (DC) voltage signal having the same potential as that of the voltage signals supplied to the second electrodes Rx in detection. This mechanism can suppress capacitive coupling between the selected second electrodes Rx and the non-selected second electrodes Rx. Consequently, the present embodiment can reduce detection errors and suppress reduction in detection sensitivity.

If a plurality of second electrodes Rx corresponding to the elements “−1” in Expression (2) are selected, the selected second electrodes Rx are coupled to the output signal line Lsig. A second output signal Vout2 obtained by integrating the second detection signals Vdet2 from the selected second electrodes Rx is output from the output signal line Lsig. Non-selected second electrodes Rx are coupled to the reference potential supply line Lr0 and supplied with the reference potential signal Vref. The signal processor 44 calculates a third output signal Vout3, which is the value of difference between the first output signal Vout1 and the second output signal Vout2.

In the example represented by Expression (2), the order of the square matrix is eight, and eight combination patterns of the second electrodes Rx are obtained. In other words, eight third output signals Vout3 are obtained corresponding to the different combination patterns of the second electrodes Rx. The signal processor 44 decodes the eight third output signals Vout3 using a transpose of the square matrix in Expression (2). Based on the decoded signal resulting from the operation, the detection apparatus 1 can detect contact or proximity of the external proximity object CQ or the shape (unevenness) of the external proximity object.

The detection apparatus 1 according to the present embodiment performs CDM drive on both of the first electrodes Tx and the second electrodes Rx. Consequently, if the arrangement interval Pt of the first electrodes Tx is small, and the area of the electrode portions 23a and 23b is small, or if the width (area) of the second electrodes Rx is small, the detection apparatus 1 can increase the detection sensitivity. The number of second electrodes Rx included in the detection electrode block BKR may be seven or less or nine or more.

In TDM drive, the output signals Vout from a plurality of second electrode blocks BKR are integrated and output to the detector 40. Consequently, the detection apparatus 1 can appropriately set the detection resolution. In TDM drive, one or a plurality of second electrodes Rx in each of the detection electrode blocks BKR may be brought into a non-selected state by the operations of the first switching elements Tra and the second switching elements Trax. The detection apparatus 1 thins out the second electrodes Rx in detection, thereby appropriately setting the signal intensity of the output signals Vout.

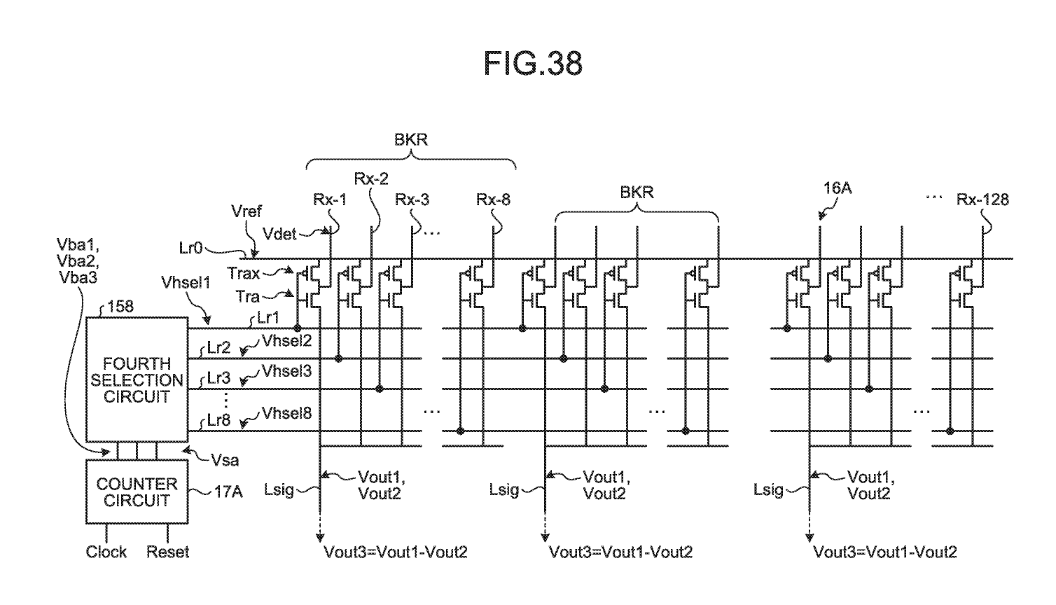

FIG. 38 is a circuit diagram of another example of the detection electrode selection circuit according to the first embodiment. A detection electrode selection circuit 16A according to the present modification includes a counter circuit 17A and a fourth selection circuit 158. The counter circuit 17A according to the present modification operates based on a clock signal Clock and a reset signal Reset supplied from the detection controller 11. The counter circuit 17A includes the flip-flop circuits 18a, 18b, 18c, and 18d of four stages, for example. The counter circuit 17A outputs an inversion control signal Vsa and three control signals Vba1, Vba2, and Vba3 to the fourth selection circuit 158.

The fourth selection circuit 158 has the same circuit configuration as that of the second code generation circuit 13 illustrated in FIG. 15, for example. The fourth selection circuit 158 generates the second electrode selection signals Vhsel1, Vhsel2, Vhsel3, . . . , and Vhsel8 based on the inversion control signal Vsa and the three control signals Vba1, Vba2, and Vba3. The second electrode selection signals Vhsel2, Vhsel2, Vhsel3, . . . , and Vhsel8 are supplied to the first switching elements Tra and the second switching elements Trax via the second electrode selection signal lines Lr1, Lr2, Lr3, . . . , and Lr8, respectively. The detection electrode selection circuit 16A thus can perform CDM drive on the second electrodes Rx. In the present modification, the number of external input terminals of the detection electrode selection circuit 16A is two, which is the number of input terminals of the counter circuit 17A. This configuration can simplify the coupling between the detection electrode selection circuit 16A and the detection controller 11 and reduce the circuit size. The fourth selection circuit 158 may have the same configuration as that of the first code generation circuit 12 and the second code generation circuit 13. In other words, the detection electrode selection circuit 16A may have the same circuit configuration as that of the first selection circuit 151. The detection electrode selection circuit 16A does not necessarily include the counter circuit 17A and may be supplied with the control signals Vba1, Vba2 and Vba3 from an external controller.

### Second Embodiment

FIG. 39 is a block diagram of the first electrode selection circuit according to a second embodiment of the present disclosure. FIG. 40 is a block diagram of the first selection circuit of the first electrode selection circuit according to the second embodiment. As illustrated in FIG. 39, in a detection apparatus 1A according to the present embodiment, a first electrode selection circuit 15A includes the first selection circuit 151, the second selection circuit 152, the third selection circuit 153, the first electrode block selection circuit 154, and an inversion control circuit 155. The inversion control circuit 155 inverts “1” and “0” of the predetermined code illustrated in FIG. 20, for example.

The inversion control circuit 155 includes a plurality of XOR circuits 167. The XOR circuits 167 are provided for the respective first electrode blocks BK. The XOR circuit 167 calculates Xor of an inversion control signal VINV supplied from the outside and the second selection signal Vg supplied from the second selection circuit 152. The inversion control circuit 155 outputs calculated fourth selection signals Vi to the third selection circuit 153.

The third selection circuit 153 calculates Xor of the fourth selection signals Vi and the first selection signals Vc. The third selection circuit 153 supplies, to the respective first electrode blocks BK, the provided third selection signals Vk as the first drive signals Vtx1 or the second drive signals Vtx2 based on the first electrode block selection signals Vh. In other words, the third selection circuit 153 generates the drive signals Vtx (the first drive signals Vtx1 or the second drive signals Vtx2) based on Expression (4).

Vtx=(Vc XOR(Vg XOR VINV)NAND Vh (4)

The present embodiment includes the inversion control circuit 155. With this configuration, as illustrated in FIG. 40, the second code generation circuit 13 does not require the second input terminal S (refer to FIG. 15) that receives the inversion control signal Vs. The counter circuit 17 includes the flip-flop circuits 18a, 18b, 18c, 18d, 18e, and 18f of six stages. The second code generation circuit 13 is supplied with the power source voltage Vdd instead of the inversion control signal Vs.

The output signal from the flip-flop circuit 18a is supplied to the second input terminal B3 of the second code generation circuit 13 as the second control signal Vb3. The output signal from the flip-flop circuit 18b is supplied to the second input terminal B2 of the second code generation circuit 13 as the second control signal Vb2. Similarly, the flip-flop circuits 18c, 18d, 18e, and 18f output the second control signal Vb1 and the first control signals Va3, Va2, and Val, respectively.

The counter circuit 17 according to the present embodiment can have a simpler configuration than in the example illustrated in FIG. 15. Specifically, the present embodiment requires a smaller number of terminals and wires that couple the counter circuit 17 and the second code generation circuit 13. Also in the configuration according to the present embodiment, the first code generation circuit 12, the second code generation circuit 13, and the third code generation circuit 14 can generate the pattern code with 64 order illustrated in FIG. 20, for example, based on the output signals from the flip-flop circuits 18 of six stages. The present embodiment can generate a pattern code obtained by replacing “1” with “0” in the pattern code illustrated in FIG. 20, for example, by the operations of the inversion control circuit 155.

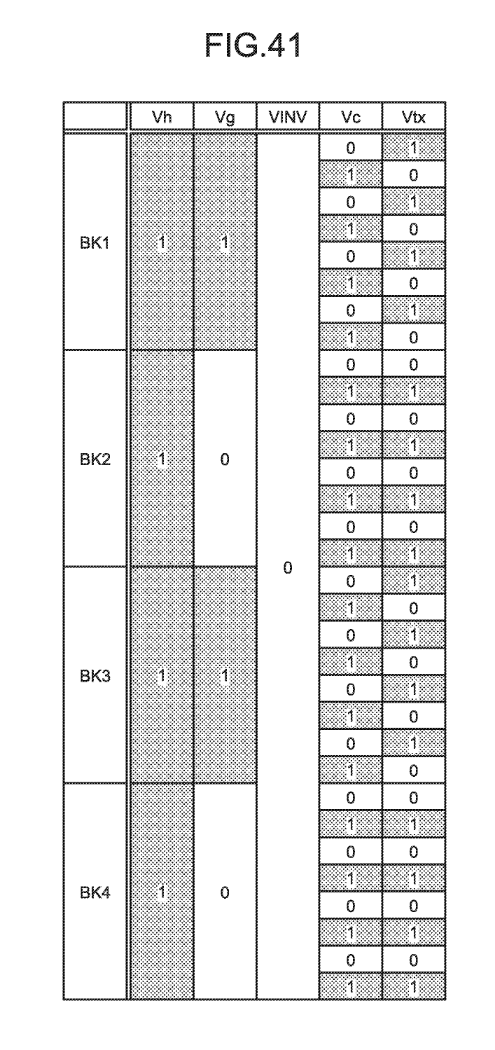

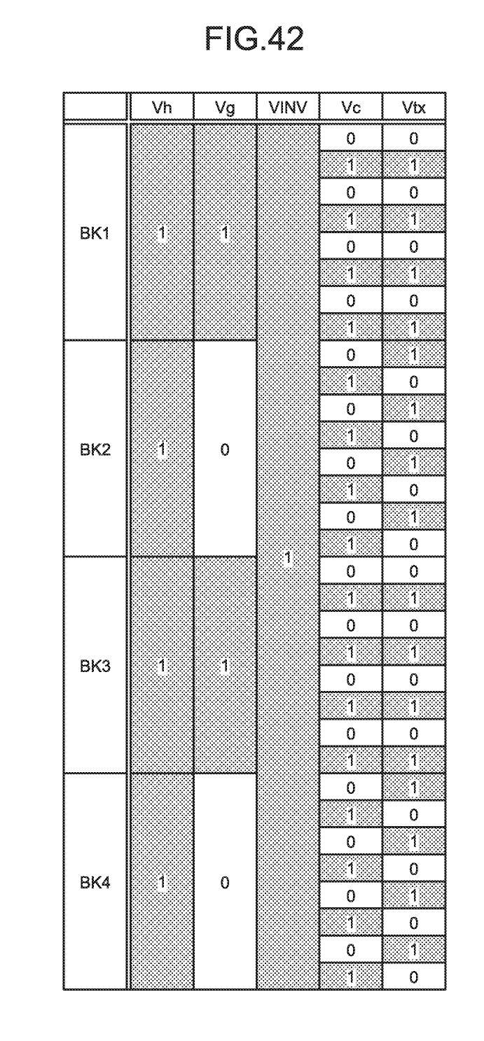

FIG. 41 is a table indicating the relation between the first electrode blocks and the selection signals if the inversion control signal is turned off in the second detection mode. FIG. 42 is a table indicating the relation between the first electrode blocks and the selection signals if the inversion control signal is turned on in the second detection mode.

As illustrated in FIGS. 41 and 42, in the second detection mode M2 (refer to FIG. 9), the first electrode block selection circuit 154 turns on (“1”) the first electrode block selection signals Vh corresponding to all the first electrode blocks BK based on the mask control signal MASK_STV. As a result, all the first electrode blocks BK are selected. The first selection circuit 151 and the second selection circuit 152 provide the first selection signals Vc and the second selection signals Vg, respectively, having the phases determined based on the predetermined code.

In FIG. 41, the inversion control signal VINV is turned off (“0”), whereby no inversion operation is performed. The third selection circuit 153 performs calculation based on Expression (4) to generate the second drive signals Vtx2. In FIG. 42, the inversion control signal VINV is turned on (“1”), whereby the predetermined code is inverted. The third selection circuit 153 performs calculation based on Expression (4) to generate second drive signals Vtx2 obtained by inverting the second drive signals Vtx2 illustrated in FIG. 41. In other words, if the inversion control signal VINV is turned on, the second drive signals Vtx2 are supplied to the first electrodes Tx not selected when the inversion control signal VINV is turned off, but no second drive signal Vtx2 is supplied to the first electrodes Tx selected when the inversion control signal VINV is turned off. The detection apparatus 1A thus can perform CDM drive on the whole surface of the detection region FA.

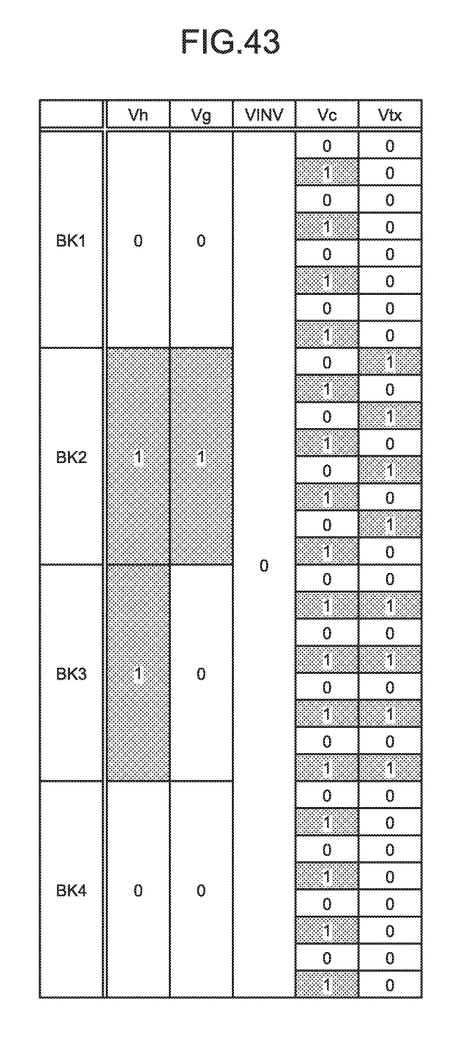

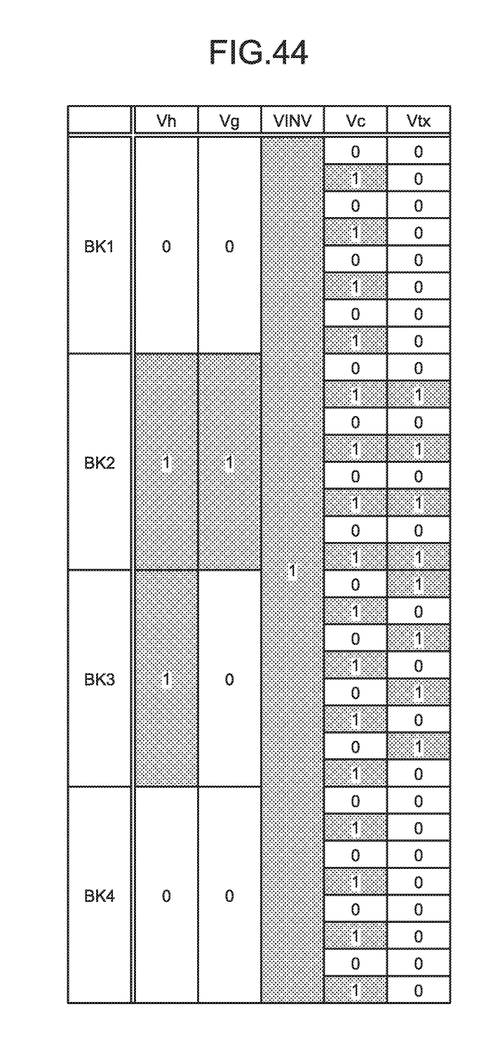

FIG. 43 is a table indicating the relation between the first electrode blocks and the selection signals if the inversion control signal is turned off in the third detection mode. FIG. 44 is a table indicating the relation between the first electrode blocks and the selection signals if the inversion control signal is turned on in the third detection mode.

In the third detection mode M3 (refer to FIG. 10), the detection apparatus 1A performs fingerprint detection on the first partial region FA1, which is part of the detection region FA. As illustrated in FIG. 43, the first electrode block selection circuit 154 turns on (“1”) the first electrode block selection signals Vh corresponding to the first electrode blocks BK2 and BK3 out of all the first electrode blocks BK based on the mask control signal MASK STV. The first electrode block selection circuit 154 turns off (“0”) the first electrode block selection signals Vh corresponding to the first electrode blocks BK1 and BK4. As a result, part of the first electrode blocks BK, that is, the first electrode blocks BK2 and BK3 are selected.

The second selection circuit 152 provides the second selection signals Vg corresponding to the selected first electrode blocks BK2 and BK3. The first selection circuit 151 provides the first selection signals Vc in the same manner as illustrated in FIGS. 41 and 42. In FIG. 43, the inversion control signal VINV is turned off (“0”), whereby no inversion operation is performed. The third selection circuit 153 performs calculation based on Expression (4) to generate the second drive signals Vtx2. The third selection circuit 153 supplies the second drive signals Vtx2 to the selected first electrode blocks BK2 and BK3. In FIG. 44, the inversion control signal VINV is turned on (“1”), whereby the predetermined code is inverted. The third selection circuit 153 performs calculation based on Expression (4) to generate second drive signals Vtx2 having the phases opposite to those of the second drive signals Vtx2 illustrated in FIG. 43. The detection apparatus 1A thus can perform CDM drive on the first partial region FA1, which is part of the detection region FA.

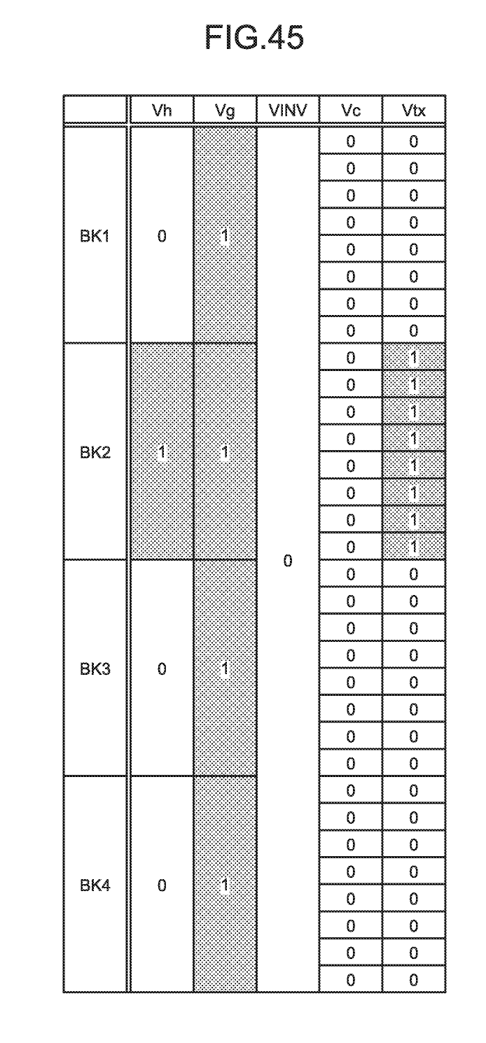

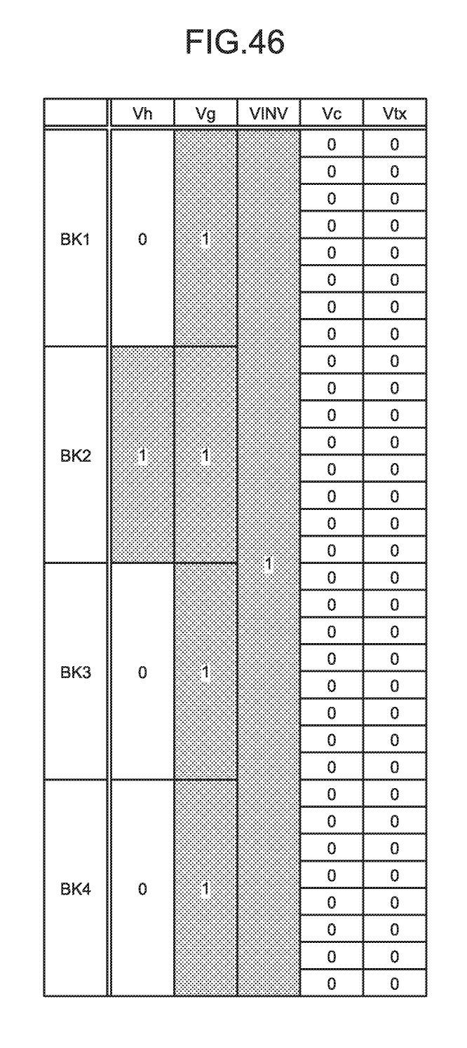

FIG. 45 is a table indicating the relation between the first electrode blocks and the selection signals if the inversion control signal is turned off in TDM drive in the first detection mode. FIG. 46 is a table indicating the relation between the first electrode blocks and the selection signals if the inversion control signal is turned on in TDM drive in the first detection mode.

As illustrated in FIG. 45, in TDM drive in the first detection mode M1 (refer to FIG. 8), the first selection circuit 151 turns off (“0”) all the first selection signals Vc. The second selection circuit 152 turns on (“1”) all the second selection signals Vg. As a result, CDM drive is not performed. The first electrode block selection circuit 154 turns on (“1”) the first electrode block selection signal Vh corresponding to the first electrode block BK2 out of the first electrode blocks BK. In FIG. 45, the inversion control signal VINV is turned off (“0”), whereby no inversion operation is performed. As a result, the first drive signal Vtx1 is supplied to the first electrode block BK2 selected by the first electrode block selection circuit 154. The first electrode block selection circuit 154 sequentially selects the first electrode blocks BK1, BK2, BK3, and BK4. As a result, the first drive signals Vtx1 are sequentially supplied to the respective selected first electrode blocks BK. In FIG. 45, the same first drive signal Vtx1 is supplied to all the first electrodes Tx in the selected first electrode block BK2. In FIG. 46, the inversion control signal VINV is turned on (“1”). As a result, no first drive signal Vtx1 is supplied to the first electrode block BK2 selected by the first electrode block selection circuit 154. The detection apparatus 1A thus can perform touch detection by TDM drive.

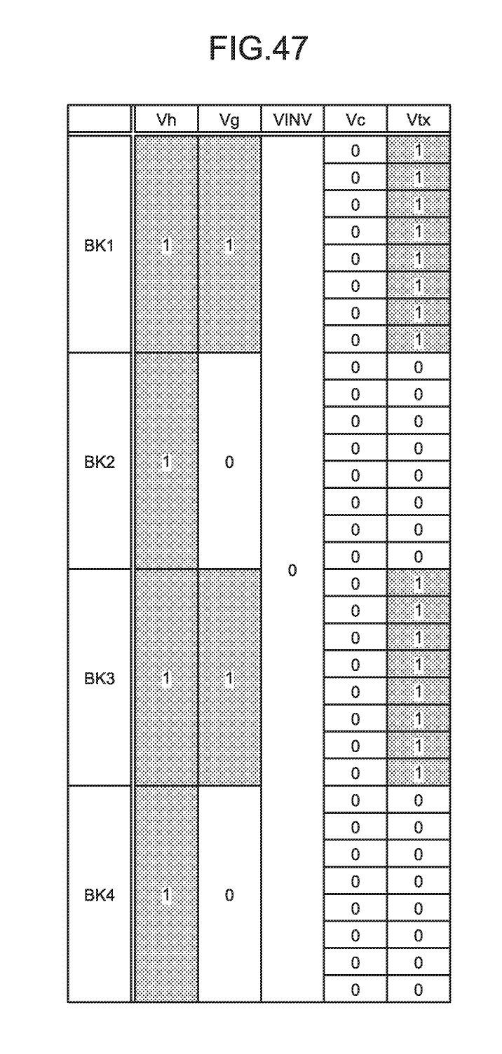

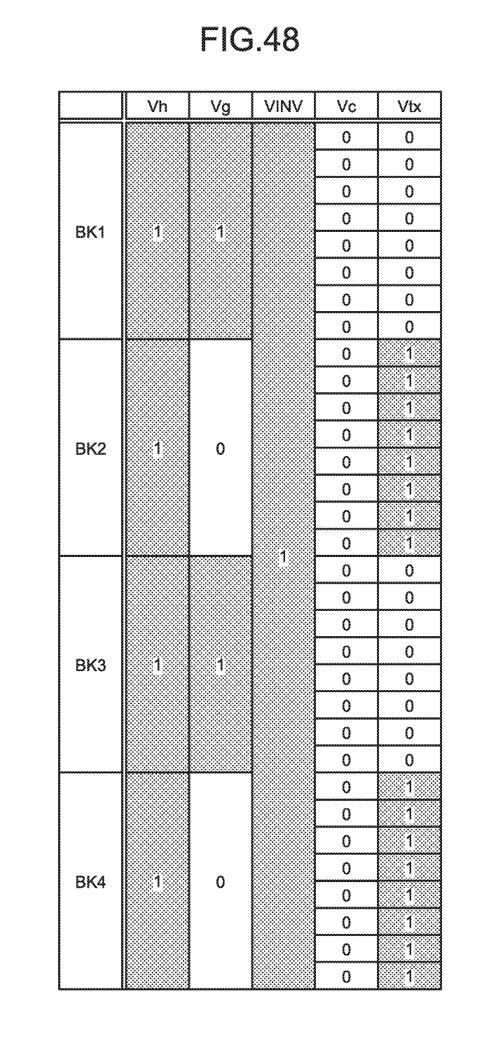

FIG. 47 is a table indicating the relation between the first electrode blocks and the selection signals if the inversion control signal is turned off in CDM drive in the first detection mode. FIG. 48 is a table indicating the relation between the first electrode blocks and the selection signals if the inversion control signal is turned on in CDM drive in the first detection mode.

As illustrated in FIG. 47, in CDM drive in the first detection mode M1 (refer to FIG. 8), the first electrode block selection circuit 154 turns on (“1”) the first electrode block selection signals Vh corresponding to all the first electrode blocks BK. As a result, all the first electrode blocks BK are selected. The first selection circuit 151 turns off (“0”) all the first selection signals Vc. In other words, CDM drive is not performed in units of the first electrode Tx.

The second selection circuit 152 outputs the second selection signals Vg having the phases determined based on the predetermined code for the respective first electrode blocks BK. In FIG. 47, the inversion control signal VINV is turned off (“0”), whereby no inversion operation is performed. The third selection circuit 153 performs calculation based on Expression (4) to generate the second drive signals Vtx2. As a result, the first drive signals Vtx1 are supplied to the first electrode blocks BK1 and BK3 selected based on the predetermined code. In FIG. 48, the inversion control signal VINV is turned on (“1”), whereby the predetermined code is inverted. The third selection circuit 153 performs calculation based on Expression (4) to generate the second drive signals Vtx2. As a result, the first drive signals Vtx1 are supplied to the first electrode blocks BK2 and BK4 selected based on the predetermined code. The second selection circuit 152 outputs the second selection signals Vg with different combination patterns of the second selection signals Vg for the respective first electrode blocks BK. The detection apparatus 1A thus performs touch detection by CDM drive.

### Third Embodiment

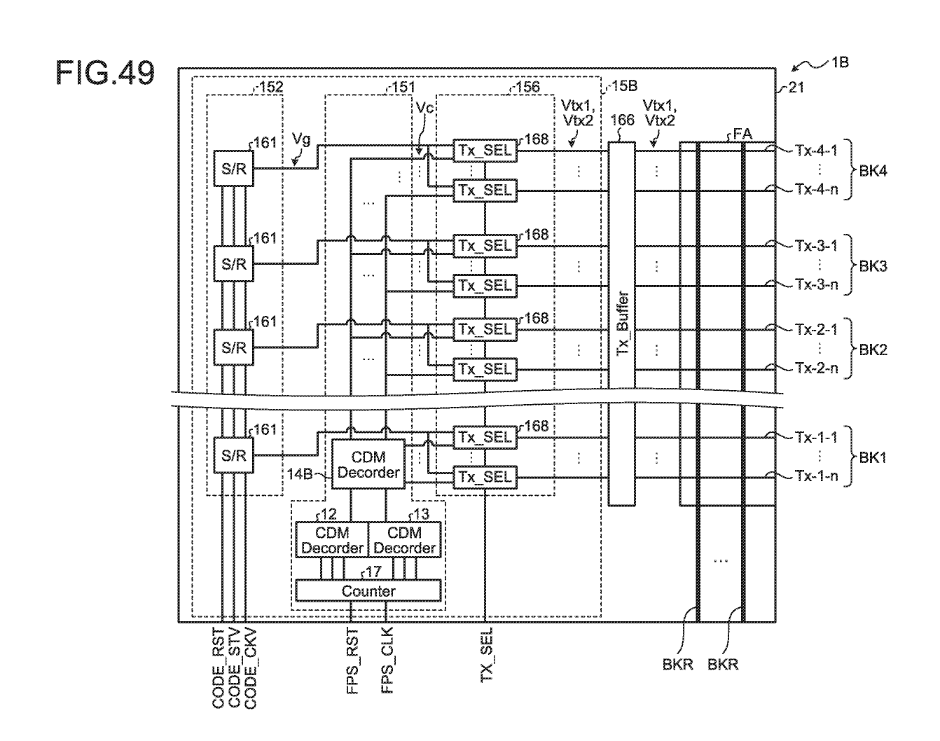

FIG. 49 is a block diagram of the first electrode selection circuit according to a third embodiment of the present disclosure. In a detection apparatus 1B according to the present embodiment, a first electrode selection circuit 15B includes the first selection circuit 151, the second selection circuit 152, and an operation mode selection circuit 156. The first selection circuit 151 is the same as that according to the first and the second embodiments. The second selection circuit 152 sequentially selects the first electrode blocks BK one by one based on the code reset signal CODE_RST, the code control signal CODE_STV, and the code clock signal CODE_CKV. The second selection circuit 152 does not include the latches 162 (refer to FIG. 14).

The operation mode selection circuit 156 includes a plurality of coupling switching circuits 168. The coupling switching circuits 168 switch coupling of the respective first electrode blocks BK to the first selection circuit 151 and the second selection circuit 152 based on a selection signal Tx_SEL. In the first detection mode M1 (refer to FIG. 8), the coupling switching circuits 168 couple the respective first electrode blocks BK to the second selection circuit 152 based on the selection signal Tx_SEL. The second selection circuit 152 sequentially outputs the second selection signals Vg to the coupling switching circuits 168 based on the code control signal CODE_STV and the code clock signal CODE_CKV. As a result, the first electrode blocks BK are sequentially selected, and the first electrode selection circuit 15B supplies the first drive signals Vtx1 to the selected first electrode blocks BK.

In the second detection mode M2 (refer to FIG. 9), the coupling switching circuits 168 couple the respective first electrode blocks BK to the first selection circuit 151 based on the selection signal Tx_SEL. The first selection circuit 151 provides the first selection signals Vc based on the first reset signal FPS_RST and the first clock signal FPS_CLK. The first selection signals Vc are voltage signals having the phases determined based on the predetermined code for the respective first electrodes Tx. The coupling switching circuits 168 output the second drive signals Vtx2 resulting from the first selection signals Vc to the first electrodes Tx in the respective first electrode blocks BK. The detection apparatus 1B thus can perform CDM drive on the whole surface of the detection region FA.

In the third detection mode M3 (refer to FIG. 10), the coupling switching circuits 168 couple part of the first electrode blocks BK to the first selection circuit 151 based on the selection signal Tx_SEL. As a result, the first electrode selection circuit 15B outputs the second drive signals Vtx2 to the selected first electrode blocks BK. The detection apparatus 1B thus performs fingerprint detection on the first partial region FA1, which is part of the detection region FA.

The configuration according to the present embodiment does not include the third selection circuit 153 and the first electrode block selection circuit 154 (refer to FIG. 14). Consequently, the configuration can reduce the circuit size of the first electrode selection circuit 15B.

### Fourth Embodiment

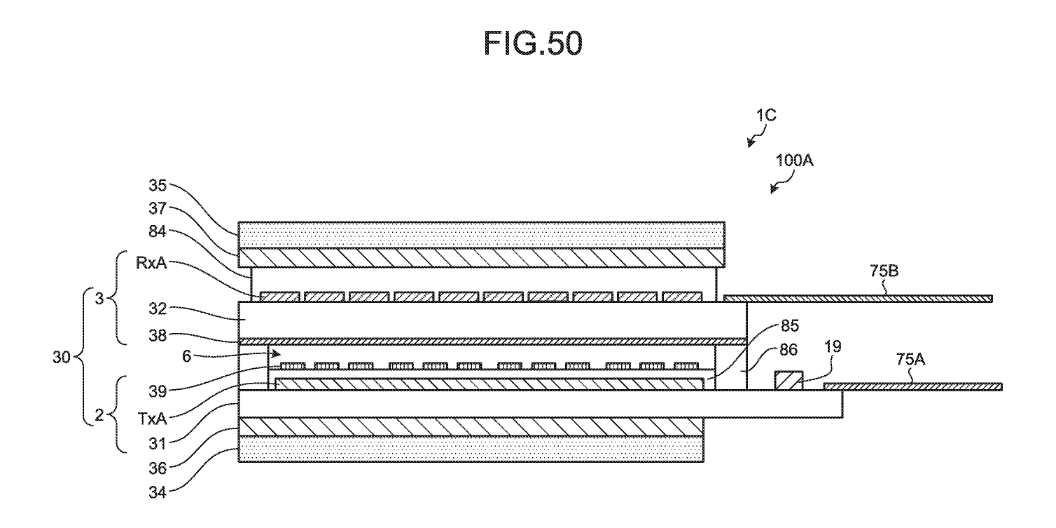

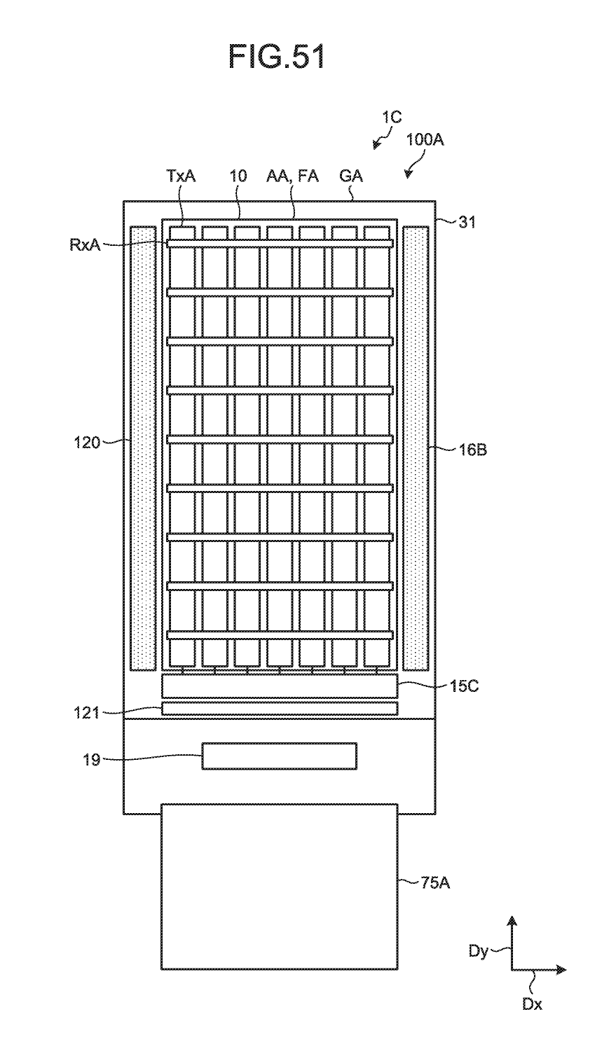

FIG. 50 is a sectional view of a schematic sectional structure of the display apparatus including the detection apparatus according to a fourth embodiment of the present disclosure. FIG. 51 is a plan view of the detection apparatus according to the fourth embodiment. A display apparatus 100A according to the present embodiment is an apparatus in which the display panel 30 and a detection apparatus 1C are integrated. An apparatus in which the display panel 30 and the detection apparatus 1C are integrated means an apparatus in which part of substrates and electrodes are shared by the display panel 30 and the detection apparatus 1C, for example.

Specifically, as illustrated in FIG. 50, the display apparatus 100A includes a pixel substrate 2, a counter substrate 3, and a liquid crystal layer 6. The counter substrate 3 is disposed facing the pixel substrate 2. The liquid crystal layer 6 is provided between the pixel substrate 2 and the counter substrate 3.

The pixel substrate 2 includes the first substrate 31, a plurality of pixel electrodes 39, a plurality of first electrodes TxA, and an insulating layer 85. The first substrate 31 is a circuit board provided with thin-film transistors (TFT) and various kinds of wiring. The pixel electrodes 39 are arrayed in a matrix (row-column configuration) on the first substrate 31. The first electrodes TxA are provided between the first substrate 31 and the pixel electrodes 39. The insulating layer 85 insulates the pixel electrodes 39 from the first electrodes TxA. The polarizing plate 34 is provided under the first substrate 31 with an adhesive layer 36 interposed therebetween.

The counter substrate 3 includes the second substrate 32, a color filter 38, and second electrodes RxA. The color filter 38 is provided on one surface of the second substrate 32. The second electrodes RxA are provided on the other surface of the second substrate 32. An insulating layer 84 is provided on the second substrate 32 to cover the second electrodes RxA. The polarizing plate 35 is provided on the insulating layer 84 with an adhesive layer 37 interposed therebetween. The first substrate 31 and the second substrate 32 according to the present embodiment are glass substrates or resin substrates, for example.

The first substrate 31 is coupled to a driver IC 19 and a flexible printed circuit board 75A. The second substrate 32 is coupled to a flexible printed circuit board 75B. The driver IC 19 is a control circuit that controls display and detection in the display apparatus 100A. Part or all of the functions of the detection controller 11 and the detector 40 may be included in the driver IC 19 or in another touch IC or another control substrate.

The first substrate 31 and the second substrate 32 are disposed facing each other with a predetermined gap formed by a sealing portion 86 interposed therebetween. The liquid crystal layer 6 is provided in the space surrounded by the first substrate 31, the second substrate 32, and the sealing portion 86. The liquid crystal layer 6 modulates light passing therethrough depending on the state of an electric field. The liquid crystal layer 6, for example, includes liquid crystals in a lateral electric-field mode, such as the in-plane switching (IPS) mode including the fringe field switching (FFS) mode. Orientation films may be provided between the liquid crystal layer 6 and the pixel substrate 2 and between the liquid crystal layer 6 and the counter substrate 3 illustrated in FIG. 50.

An illuminator is provided under the first substrate 31. The illuminator includes a light source, such as a light emitting diode (LED), and outputs light from the light source toward the first substrate 31. The light output from the illuminator passes through the pixel substrate 2. The display apparatus 100A switches the portions that block and prevent the light from being output and the portions that allow the light to be output depending on the state of liquid crystals at the corresponding positions, thereby displaying an image on the display surface. If the display apparatus 100A is a reflective liquid crystal display apparatus including reflective electrodes that reflect light entering from the second substrate 32 side as the pixel electrodes 39 and including translucent second electrodes RxA on the counter substrate 3 side, the illuminator is not necessarily provided under the first substrate 31. The reflective liquid crystal display apparatus may include a front light on the second substrate 32. In this case, light entering from the second substrate 32 side is reflected by the reflective electrodes (pixel electrodes 39), passes through the second substrate 32, and reaches the eyes of an observer. If the display panel 30 (refer to FIG. 50) is an OLED, the display panel 30 includes self-luminous bodies for respective pixels. In this case, the display panel 30 displays an image by controlling the lighting quantities of the respective self-luminous bodies. Consequently, the display apparatus 100A requires no illuminator. If the display panel 30 is an OLED, the display layer may be included in the pixel substrate 2. A luminous layer serving as the display layer, for example, may be disposed between the first electrodes TxA and the pixel electrodes 39.

As illustrated in FIG. 51, the display apparatus 100A includes the first electrodes TxA and the second electrodes RxA in the region overlapping the display region AA. The first electrodes TxA extend in a direction (second direction Dy) along one side of the display region AA and are arrayed in a direction (first direction Dx) along the other side of the display region AA with a space interposed therebetween. The first electrodes TxA are coupled to a first electrode selection circuit 15C. The first electrodes TxA are made of a translucent conductive material, such as ITO. The first electrodes TxA may be made of a metal material.

The second electrodes RxA extend in the first direction Dx and are arrayed in the second direction Dy with a space interposed therebetween. In other words, the first electrodes TxA and the second electrodes RxA intersect in planar view, and capacitance is formed at the overlapping portions. The second electrodes RxA are coupled to a detection electrode selection circuit 16B. The second electrodes RxA are made of a metal material, for example. The second electrodes RxA may be made of a translucent conductive material, such as ITO. The first electrodes TxA and the second electrodes RxA do not necessarily have a rectangular shape and may have a mesh shape, for example.

The first substrate 31 is further provided with a gate driver 120 and a source driver 121. The gate driver 120 has a function of sequentially selecting one horizontal line to be a target of display drive in the display panel 30. The source driver 121 is a circuit that supplies pixel signals to the respective pixels in the display panel 30.

In a display operation, the gate driver 120 sequentially selects one horizontal line out of the pixels as a target of display drive. The display apparatus 100A causes the source driver 121 to supply the pixel signals to the pixels belonging to one horizontal line, thereby performing display in units of one horizontal line. The driver IC 19 applies display drive signals to all the first electrodes TxA. In other words, the first electrodes TxA serve as common electrodes that supply a common potential to a plurality of pixels.

In a detection operation, the first electrode selection circuit 15C supplies the second drive signals Vtx2 having the phases determined based on a predetermined code to the first electrodes TxA. The detection apparatus 1C thus performs CDM drive. The first electrode selection circuit 15C supplies the first drive signals Vtx1 to the respective first electrode blocks BK. The first electrode selection circuit 15C has the same configuration as that according to any one of the first to the third embodiments.

The second electrodes RxA output the signals corresponding to changes in capacitance between the first electrodes TxA and the second electrodes RxA. The detection electrode selection circuit 16B selects the second electrodes RxA based on a predetermined code. A detection apparatus 1D thus performs touch detection or fingerprint detection.

The display apparatus 100A may perform the display operation and the detection operation in a time-division manner. The display apparatus 100A may perform the display operation and the detection operation in any division manner. The display apparatus 100A, for example, performs the touch detection operation and the display operation by dividing them into a plurality of sections in one frame period of the display panel 30, that is, in a time required to display video information of one screen.

While exemplary embodiments according to the present disclosure have been described, the embodiments are not intended to limit the disclosure. The contents disclosed in the embodiments are given by way of example only, and various changes may be made without departing from the spirit of the disclosure. Appropriate modifications made without departing from the spirit of the present disclosure naturally fall within the technical scope of the disclosure.

What is claimed is:

1. A detection apparatus comprising:
a substrate;
a plurality of first electrodes provided on the substrate; and
a first electrode selection circuit provided on the substrate and including a first selection circuit configured to provide a first selection signal having a phase determined for each of the plurality of first electrodes and a second selection circuit configured to provide a second selection signal having a phase determined for each of first electrode blocks including the plurality of first electrodes, wherein
the first electrode selection circuit has
a first detection mode of supplying same signal of the first drive signal to each of the first electrode blocks in a time-division manner based on the first selection signal and the second selection signal, and
the first electrode selection circuit has a second detection mode of supplying, to the plurality of first electrodes, a second drive signal having a phase determined for each of the plurality of first electrodes based on the first selection signal and the second selection signal.

2. The detection apparatus according to claim 1, wherein the first electrode selection circuit further includes a third selection circuit configured to provide a third selection signal for selecting first electrodes included in the first electrode blocks based on the first selection signal and the second selection signal.

3. The detection apparatus according to claim 2, wherein
the first selection circuit supplies the first selection signal at a low-level voltage to the third selection circuit in the first detection mode, and
the second selection circuit supplies the second selection signal having the phase determined for each of the first electrode blocks to the third selection circuit in the first detection mode.

4. The detection apparatus according to claim 1, wherein the second selection circuit is a shift register including a plurality of logic circuits provided corresponding to the first electrode blocks respectively.

5. The detection apparatus according to claim 1, wherein the first electrode selection circuit further includes a first electrode block selection circuit configured to select at least one first electrode block from the first electrode blocks.

6. The detection apparatus according to claim 5, wherein
the first electrode block selection circuit sequentially selects the at least one first electrode block in a time-division manner in the first detection mode, and
the first electrode selection circuit supplies the first drive signal to the at least one first electrode block.

7. The detection apparatus according to claim 5, wherein the first electrode selection circuit supplies the second drive signal to the at least one first electrode block selected by the first electrode block selection circuit in the second detection mode.

8. The detection apparatus according to claim 5, wherein the first electrode block selection circuit is a shift register including a plurality of logic circuits provided corresponding to the first electrode blocks respectively.

9. The detection apparatus according to claim 1, wherein a second period in which the first electrode selection circuit supplies the second drive signal to the plurality of first electrodes in the second detection mode is longer than a first period in which the first electrode selection circuit sequentially supplies the first drive signal to all the first electrode blocks in the first detection mode.

10. The detection apparatus according to claim 2, wherein
the third selection circuit includes exclusive OR circuits or exclusive NOR circuits provided for the first electrode blocks respectively, and
the third selection signal is a signal based on exclusive or of the first selection signal and the second selection signal or negation of exclusive or of the first selection signal and the second selection signal.

11. The detection apparatus according to claim 1, further comprising:
a plurality of second electrodes configured to form capacitance between the plurality of second electrodes and the plurality of first electrodes, wherein
the first drive signal or the second drive signal is simultaneously supplied to first electrodes selected based on the first selection signal and the second selection signal, and
the plurality of second electrodes output a detection signal corresponding to a change in capacitance.

12. The detection apparatus according to claim 11, further comprising:
a detection electrode selection circuit configured to select at least one second electrode from the plurality of second electrodes, wherein
the detection electrode selection circuit couples the at least one second electrode to one output signal line.

13. The detection apparatus according to claim 12, wherein the detection electrode selection circuit couples a non-selected second electrode out of the plurality of second electrodes to a reference potential supply line configured to supply a reference voltage signal.

14. The detection apparatus according to claim 11, wherein
the plurality of first electrodes each include a plurality of electrode portions arrayed in a first direction in a plane parallel to the substrate and a plurality of couplers coupling the electrode portions in the first direction, and
the plurality of second electrodes intersect the couplers in planar view and have a long side extending in a second direction intersecting the first direction.

15. The detection apparatus according to claim 14, wherein
the electrode portions are arrayed along the plurality of second electrodes, and
the width of the electrode portions is larger than the width of the plurality of second electrodes in the first direction.

16. The detection apparatus according to claim 14, wherein
the electrode portions are made of a translucent conductive material, and
the plurality of second electrodes are made of a metal material.

17. The detection apparatus according to claim 1, wherein an arrangement interval of the plurality of first electrodes is equal to or smaller than 100 μm.

18. A detection apparatus comprising:
a substrate;
a plurality of first electrode blocks provided on the substrate, each of the first electrode blocks including a plurality of first electrodes; and
a first electrode selection circuit provided on the substrate and including a first selection circuit configured to provide a first selection signal having a phase determined for each of the plurality of first electrodes included in one first electrode block and a second selection circuit configured to provide a second selection signal for each of the first electrode blocks including the plurality of first electrodes, wherein
the first selection circuit supplies, in at least the first electrode blocks disposed side by side, same signal of the first selection signal to electrodes provided respectively at the same position in the direction in which the first electrode blocks are disposed side by side,
the second selection circuit supplies same signal of the second drive signal to first electrodes included in at least one first electrode block,
the first electrode selection circuit has a first detection mode of supplying same signal of the first drive signal to each of the first electrode blocks in a time-division manner based on the first selection signal and the second selection signal, and
the first electrode selection circuit has a second detection mode of supplying, to the plurality of first electrodes, a second drive signal having a phase determined for each of the plurality of first electrodes based on the first selection signal and the second selection signal.

19. A display apparatus comprising:
the detection apparatus according to claim 1; and
a display panel configured to display an image, wherein
the detection apparatus is provided on the display panel.

20. A display apparatus comprising:
the detection apparatus according to claim 1; and
a display panel configured to display an image, wherein
the plurality of first electrodes are common electrodes configured to supply a common potential to a plurality of pixels in the display panel.
